(19) United States
(12) Patent Application Publication
(10) Pub. No.: US 2021/0388216 A1
(43) Pub. Date: Dec. 16, 2021

(54) Crosslinked Aromatic Polymer Compositions and Methods of Making Insulation Coatings For Use on Components Subject to High Temperature, Corrosive and/or High Voltage End Applications

(71) Applicant: Greene, Tweed Technologies, Inc., Wilmington, DE (US)

(72) Inventors: Kerry A. Drake, Red Hill, PA (US); Le Song, Chalfont, PA (US); Richard Gavlik, The Woodlands, TX (US)

(73) Assignee: Greene, Tweed Technologies, Inc.

(21) Appl. No.: 17/328,150

(22) Filed: May 24, 2021

Related U.S. Application Data
(60) Provisional application No. 63/029,524, filed on May 24, 2020.

(51) Int. Cl. C09D 5/08; C09D 5/18; C09D 171/00

(52) U.S. Cl. CPC C09D 5/08; C09D 171/00; C09D 5/18

(57) ABSTRACT

Methods are provided for forming crosslinked aromatic polymer coatings. Such coatings may be used on or to encapsulate an insulation component. The coatings are formed for use in a high temperature, high voltage and/or corrosive environments. The method includes providing a composition comprising at least one crosslinkable aromatic polymer; heat processing the composition; applying a coating of the composition to an exterior surface of an insulation component; and crosslinking the aromatic polymer in the composition to provide a coated insulation component.

### CROSS-REFERENCE TO RELATED APPLICATIONS

This application claims the benefit under 35 U.S.C. § 119(e) to U.S. Provisional Patent Application No. 63/029,524, filed May 24, 2020, entitled, “Crosslinked Aromatic Polymer Compositions and Methods of Making Insulation Coatings for Use on Components Subject to High Temperature, Corrosive and/or High Voltage End Applications,” the entire disclosure of which is incorporated herein by reference.

### BACKGROUND OF THE INVENTION

### Field of the Invention

The field of the invention relates to cross-linked aromatic polymer coatings for application to components that are subject to harsh or corrosive chemicals, high temperatures and/or high voltage end applications, such as those encountered in down-hole oil and similar environments. In particular, the field includes coatings for wire and other components for such uses that demonstrate improved insulative, chemical resistance and high temperature resistance.

### Description of Related Art

The aerospace and energy industries, among others, have a high demand for polymer coatings to insulate and safeguard products such as cable, wire, fiber optic cables, hybrid cables, individual fiber or other devices and components that will be subject to high temperatures, high voltage and/or harsh or corrosive chemicals as might be encountered in downhole tooling, motors, magnets, submersible pumps, telemetry cables for logging and measuring while drilling and in other operations where sensors are used to measure conditions downhole or in other remote locations. Further, when devices are connected through wire(s) and/or cables and a signal must be transmitted from a sensor in a working environment through the wire or cables to a measuring or logging equipment, accuracy and performance are important. Such wires and cables may also be used in aerospace components and in fluid handling components.

Typically, such industries have employed coatings formed of high performance engineering polymers, including polyarylene or polyarylene ether polymers, like polyetherether ketone (PEEK), polyether ketone (PEK), polyetherketone ketone (PEKK) and polyetherdiphenylether ketone (PEDEK), as well as polyetherimide (PEI), polybenzimidazole (PBI), polyphenylene sulfide (PPS), polyphenylsulfone (PPSU), polyetherimide (PEI), and polyimides for such environments. While they are acceptable, they have limits in terms of the temperatures at which such materials may be used. Further, amorphous polymers, such as PEI and PPSU as well as some grades of PEEK cannot be used above their glass transition temperature (T_{g}) due to catastrophic softening (which can cause a 90-99% property drop), and an increase in tackiness. Semicrystalline polymers can be employed at temperatures above their T_{g}, but can experience a large drop-off in mechanical and electrical properties at such elevated temperatures due to the higher molecular mobility experienced by the polymers above their T_{g}.

High performance polymers are often used as insulation materials for wire coating and insulation coatings of components exposed to aggressive conditions. The insulation properties of polymeric materials can be significantly affected by temperature, electric current or high voltage and exposed media. Amorphous polymers have a higher T_{g}, but are more sensitive to exposed media. Semi-crystalline polymers have better chemical resistance, but a relatively low T_{g} thereby limiting the useful application temperatures. Polymer blends, copolymerization and cross-linking are approaches which have been used to improve standard polymer properties such as heat resistance and/or chemical resistance of polymers. Polymer blends can improve some properties, but often with a negative impact on others. Copolymerization requires extended development of new molecular designs and synthesis.

Initial attempts to use cross-linked aromatics alone or in blends to create materials, including thin films for use in dielectric components for using grafting and thermal crosslinking are known. See, e.g., U.S. Pat. Nos. 6,061,170, 6,187,248, 6,716,955, 7,179,878, 7,919,825 and 8,502,401. Such materials were acceptable in small films, but had difficulty in preparing materials for use in other end applications.

Prior art application of compositions including an aromatic polymer and a crosslinking compound were developed by the applicant herein and have been employed to achieve materials with a high glass transition temperature compared to a non-cross-linked polymer as described in U.S. Pat. No. 9,006,353 B2. Such compositions are also described by the applicant in U.S. Pat. No. 9,109,080 in combination with a cross-linking additive to control the rate of crosslinking to enable melt processing of parts, such as by extrusion or injection molding, to achieve improved mechanical properties at elevated temperatures for use in extrusion-resistant sealing components. See, U.S. Pat. Nos. 9,475,938 and 9,127,938.

While such achievements have been made, there is still a need in the art for the ability to use and adapt aromatic materials to harness their benefits in terms of properties and also being able to process them in a manner in which they can be readily processed to form coatings for components in harsh, corrosive environments, high temperature and/or high voltage end applications, while retaining their mechanical, heat-resistant and insulative properties, avoiding property drop-off and harnessing cross-linked aromatic materials in a manner to maximize their mechanical and electrical properties in such end applications.

### BRIEF SUMMARY OF THE INVENTION

The invention includes a method of coating an insulation component with a crosslinked aromatic polymer for use in a high temperature, high voltage and/or corrosive environments, comprising: providing a composition comprising at least one crosslinkable aromatic polymer, and optionally a crosslinking compound if needed for curing; heat processing the composition; applying a coating of the composition to an exterior surface of an insulation component; and crosslinking the aromatic polymer in the composition to provide a coated insulation component.

The crosslinking may be initiated by application of heat. The at least one crosslinkable aromatic polymer may comprise a self-crosslinking aromatic polymer, or, for example, may include one or more crosslinkable aromatic polymer curable through use of a crosslinking compound and/or other additive. The crosslinking may be initiated after coating the insulation component. In another embodiment, the crosslinkable aromatic polymer may be at least partially crosslinked during the coating of the insulation component. Further, in another embodiment, the crosslinking may occur generally simultaneously with the coating of the insulation component.

The at least one crosslinkable aromatic polymer may be selected from polyarylenes, polysulfones, polyethersulfones, polyphenylene sulfides, polyphenylsulfones, polyimides, polyetherimides and thermoplastic polyimides (TPI), polybenzamide, polyamide-imide, aromatic polyurea, polyurethane, polyphenylene oxide, polyphthalamide, polybenzimidazole, polyaramid, and blends, co-polymers, and alloys thereof. The aromatic polymer may also comprise one or more functionalized groups for crosslinking.

The aromatic polymer in a preferred embodiment is a polyarylene selected from polyetherketone, polyetheretherketone, polyetherketone ketone, polyetherdiphenylether ketone and blends, co-polymers and alloys thereof. In one embodiment, the at least one crosslinkable polymer is a polyarylene ether having repeating units along its backbone according to the structure of formula (I):

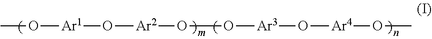

wherein Ar¹, Ar², Ar³ and Ar⁴ are identical or different aryl radicals, m=0 to 1, and n=1-m.

In one embodiment of the method, the at least one crosslinkable aromatic polymer of formula (I) above may have repeating units along its backbone having the structure of formula (II):

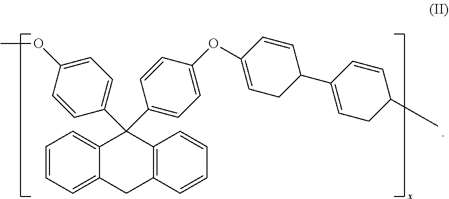

In the method the at least one crosslinkable aromatic polymer may comprise a blend of at least two different polymers, each having at least one reaction kinetics property that is different from the other, wherein the at least one reaction kinetics property comprises one or more selected from a crosslinking reaction, a crosslinking reaction rate, and a thermal property. In a preferred embodiment, the at least one reaction kinetics property is the crosslinking reaction rate. Such a blend may be selected from the group of polyphenylene sulfide and polyetherether ketone; polyphenylene oxide and polyphenylene sulfide; and polyetherimide and polyphenylene sulfide. In one preferred embodiment, the blend includes at least one first crosslinkable aromatic polymer that has a crosslinking reaction rate that is slower than at least one second crosslinkable aromatic polymer. In such a blend, the at least one first crosslinkable polymer is polyphenylene sulfide and the at least one second crosslinkable polymer is selected from the group consisting of (i) one or more polyarylene selected from polyetherketone, polyetheretherketone, polyetherdiephenylether ketone, polyetherketone ketone, and blends, co-polymers and alloys thereof; (ii) one or more of polysulfone, polyphenylsulfone, polyethersulfone, co-polymers and allows thereof; and (iii) one or more of polyimide, thermoplastic polyimide, polyetherimide, and blends, co-polymers and allows thereof.

Such blends may further preferably comprise at least two polymers that are of different reaction kinetics (e.g., different reactions, reaction rates, thermal properties, reactivity and the like) to assist in controlling a crosslinking reaction rate without adding a crosslinking reaction control additive, including preferred blends when one of the polymers has a slower crosslinking reaction rate than one or more other polymers in the blend. In one embodiment of the method, the blend comprises at least one first crosslinkable aromatic polymer that has a crosslinking reaction rate that is slower than at least one second crosslinkable aromatic polymer. In such an embodiment, the method may further comprise slowing the crosslinking reaction rate of the second crosslinkable aromatic polymer by incorporating the first crosslinkable aromatic polymer into the second crosslinkable aromatic polymer in an amount that is about 1 to about 50 percent by weight based on the total weight of the first and the second crosslinkable aromatic polymers to provide a degree of crosslinking for the blend that facilitates melt processing and post-curing of the blend. Alternatively, the method may further comprise accelerating the crosslinking reaction rate of the first crosslinkable aromatic polymer by incorporating the second crosslinkable aromatic polymer into the first crosslinkable aromatic polymer in an amount that is about 1 to about 50 percent by weight based on the total weight of the first and the second crosslinkable aromatic polymers to provide a degree of crosslinking for the blend that facilitates melt processing and post-curing of the blend.

The composition used in the method may further comprise at least one crosslinking compound that has a structure according to one of the following formulae:

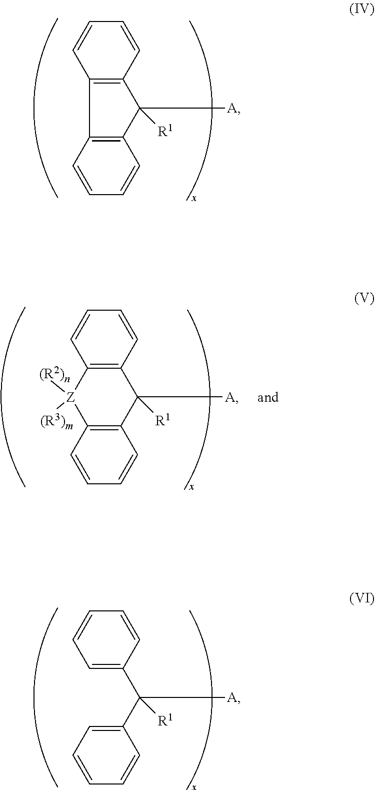

wherein A may be a bond, an alkyl, an aryl, or an arene moiety having a molecular weight less than about 10,000 g/mol; wherein R¹, R², and R³ may be the same or different and may be independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is preferably from 0 to 2, n is preferably from 0 to 2, and m+n is preferably greater than or equal to zero and less than or equal to two; wherein Z may be selected from the group of oxygen, sulfur, nitrogen, and a branched or straight chain, saturated or unsaturated alkyl group of one to about six carbon atoms; and wherein x is preferably about 1 to about 6.

The at least one crosslinking compound may further have a structure according to formula (IV) and be selected from the group consisting of

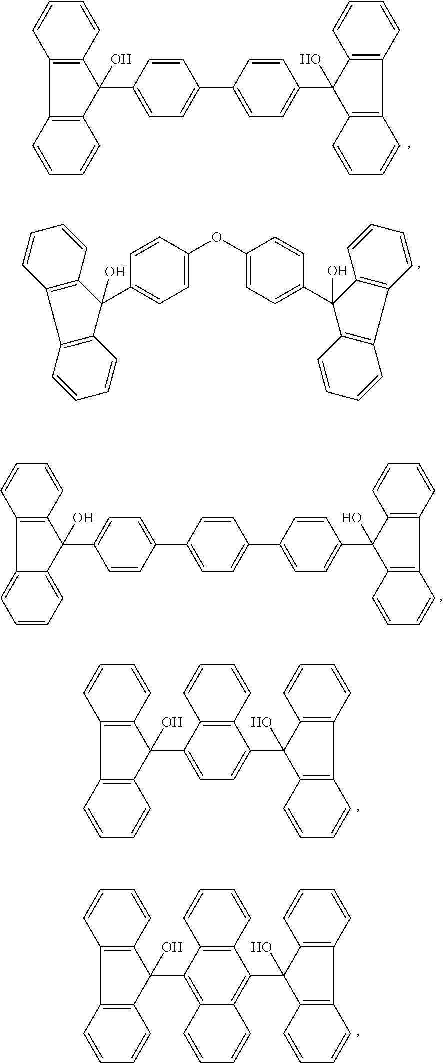 [SMILES: OC1(c2ccc(-c3ccc(C4(O)c5ccccc5-c5ccccc54)cc3)cc2)c2ccccc2-c2ccccc21 ; OC1(c2ccc(Oc3ccc(C4(O)c5ccccc5-c5ccccc54)cc3)cc2)c2ccccc2-c2ccccc21 ; OC1(c2ccc(-c3ccc(-c4ccc(C5(O)c6ccccc6-c6ccccc65)cc4)cc3)cc2)c2ccccc2-c2ccccc21 ; OC1(c2ccc(C3(O)c4ccccc4-c4ccccc43)c3ccccc23)c2ccccc2-c2ccccc21 ; OC1(c2c3ccccc3c(C3(O)c4ccccc4-c4ccccc43)c3ccccc23)c2ccccc2-c2ccccc21]

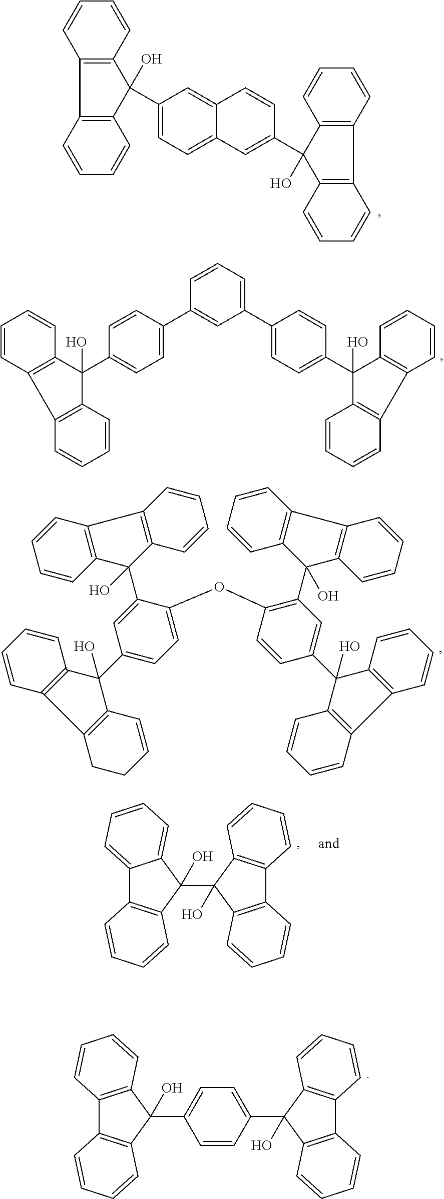

The at least one crosslinking compound may further have a structure according to formula (V) and be selected from a group consisting of:

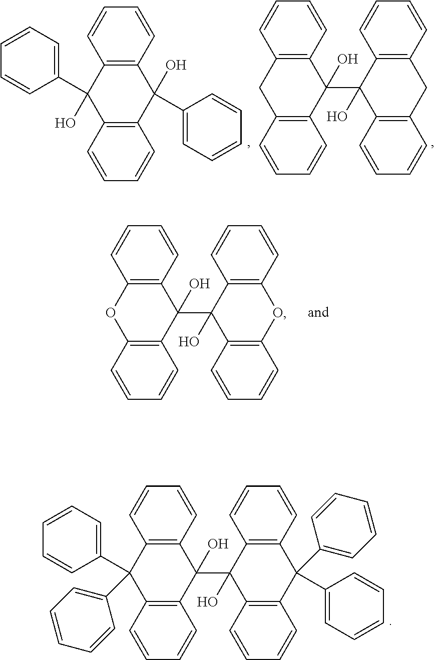

The at least one crosslinking compound may have a structure according to formula (VI) and be selected from the group consisting of:

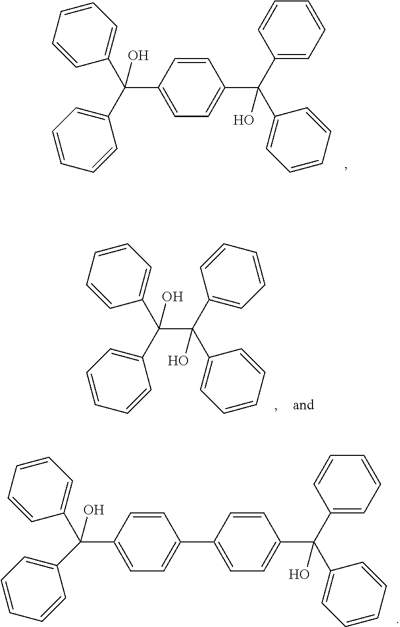 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

In one embodiment, A may have a molecular weight of about 1,000 g/mol to about 9,000 g/mol, and preferably A may have a molecular weight of about 2,000 g/mol to about 7,000 g/mol.

The at least one crosslinking compound may be present in the composition used in the method in an amount of about 1% by weight to about 50% by weight of an unfilled weight of the composition. The weight ratio of the aromatic polymer to the crosslinking compound in the composition may be about 1:1 to about 100:1.

The composition used in the method may further comprise a crosslinking reaction control additive selected from a cure inhibitor or a cure accelerator. Such a crosslinking reaction control additive may be present in the composition in an amount of about 0.01% to about 15% by weight of the crosslinking compound. The crosslinking reaction control additive may be a cure inhibitor comprising alkaline additives and fillers such as lithium acetate. The crosslinking reaction control additive may also be a cure accelerator comprising acidic additives and fillers such as magnesium chloride.

The composition of the method may also comprise one or more additives selected from continuous or discontinuous, long or short, reinforcing fibers selected from carbon fibers, glass fibers, woven glass fibers, woven carbon fibers, aramid fibers, boron fibers, polytetrafluoroethylene (PTFE) fibers, ceramic fibers, polyamide fibers, and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, carbon nanotubes and fullerene tubes. The composition may comprise about 0.5% by weight to about 65% by weight of the one or more additives and/or one or more fillers. In the method, the composition may further comprise a crosslinking compound.

The heat processing of the composition may further comprise extruding the composition for coating the insulation component. The composition may be extruded through a cross-head die. The extruder may be a twin-screw extruder or a single-screw extruder. In the method, curing may occur at least partially in an oven. The oven may be an infrared or convection oven.

The method may further comprise curing and/or post-curing the crosslinkable aromatic polymer after coating in the oven. The residence time in the oven and/or the cross-linking rate may be controlled during coating formation, as well as the draw rate for coating of wires and/or cables and the like in preferred embodiments herein.

The method may further comprise preparing the exterior surface of the insulation component to enhance bonding. The exterior surface may be prepared by at least one of cleaning, roughening and/or chemically modifying the surface. The exterior surface may be prepared by chemically modifying the exterior surface using a primer and/or a coupling agent.

Applying a coating to the exterior surface of the insulation component may comprise applying the composition directly to the exterior surface of the insulation component. In such an embodiment, the exterior surface may be prepared by at least one of cleaning the surface, roughening the surface and/or chemically modifying the surface.

The method may further comprise applying at least one intermediate layer to the exterior surface of the insulation product prior to applying the coating of the composition, e.g., an uncrosslinked aromatic compound. In the method, the at least one intermediate layer may provide the ability to enhance bonding with the exterior surface of the insulation component.

The coating of the composition may further encapsulate the insulation component.

The method may further comprise applying a release agent to the coating prior to the coating contacting another surface.

The insulation components for coating may be, e.g., wire, metallic and/or fiber optic cable, hybrid cables, telemetry cables, sensors, RFID chips, piezoelectric sensors, cables or wires for logging while drilling, motor windings, motor rotors, motor stators, chemical pumps, electronic actuators for aircraft, and 5G transmission cables, among others.

The method further comprises a coated insulation component formed from the method as described herein. In one embodiment herein, the coated insulation component formed from methods herein may have a coating formed from the compositions noted herein including the crosslinked polymer on the coated insulation component that provides improved wear resistance relative to a coated insulation component coated with a composition having an uncrosslinked aromatic polymer of the same polymer backbone structure.

In another embodiment, the coated insulation component may have improved insulation resistance at a high service temperature over a range of voltages relative to a coated insulation component coated with a composition having an uncrosslinked aromatic polymer of the same polymer backbone structure.

In another embodiment, the coated insulation component has improved dielectric breakdown resistance at a high service temperature relative to a coated insulation component coated with a composition having an uncrosslinked aromatic polymer of the same polymer backbone structure.

The invention further includes a composition for coating an insulation component, comprising: a first crosslinkable aromatic polymer and a second crosslinkable aromatic polymer, wherein the first crosslinkable aromatic polymer has at least one reaction kinetics property that is different from the same reaction kinetics property in the second crosslinkable aromatic polymer, wherein the at least one reaction kinetics property comprises one or more selected from a crosslinking reaction, a crosslinking reaction rate, and a thermal property. In the composition, the first crosslinkable polymer and the second crosslinkable polymer may be selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof. Either of the first and second crosslinkable aromatic polymers or all of the crosslinkable aromatic polymers may comprise one or more functionalized groups for crosslinking.

The second crosslinkable aromatic polymer may be one or more of the following polyarylenes, including but not limited to those selected from polyetherketone, polyetheretherketone, polyetherdiephenylether ketone, polyetherketone ketone, and blends, co-polymers and alloys thereof. The at least one reaction kinetics property is preferably the crosslinking reaction rate. The first crosslinkable aromatic polymer preferably has a crosslinking reaction rate that is slower than the second crosslinkable aromatic polymer.

In one embodiment, the blend comprises from about 1 percent to about 50 percent by weight of the first crosslinkable aromatic polymer and about 50 percent by weight to about 1 percent by weight of the second crosslinkable polymer, and a range of the weight percentage ratio of the first crosslinkable aromatic polymer to the second crosslinkable aromatic polymer is about 1:50 to about 50:1 to provide a degree of crosslinking for the blend to facilitate melt processing and post-curing of the blend.

The at least one first crosslinkable polymer in one preferred embodiment is polyphenylene sulfide and the at least one second crosslinkable polymer in such embodiment may be selected from the following: (i) one or more polyarylene selected from polyetherketone, polyetheretherketone, polyetherdiephenylether ketone, polyetherketone ketone, and blends, co-polymers and alloys thereof; (ii) one or more of polysulfone, polyphenylsulfone, polyethersulfone, co-polymers and allows thereof; and (iii) one or more of polyimide, thermoplastic polyimide, polyetherimide, and blends, co-polymers and allows thereof. In a further preferred embodiment, the second crosslinkable aromatic polymer may be selected from the group of polyetherether ketone; polyphenylene oxide, and polyetherimide

The composition may further comprise one or more additional aromatic crosslinkable polymers, different from the first and the second aromatic crosslinkable polymers.

The composition may further comprise at least one crosslinking compound that has a structure according to one of the following formulae:

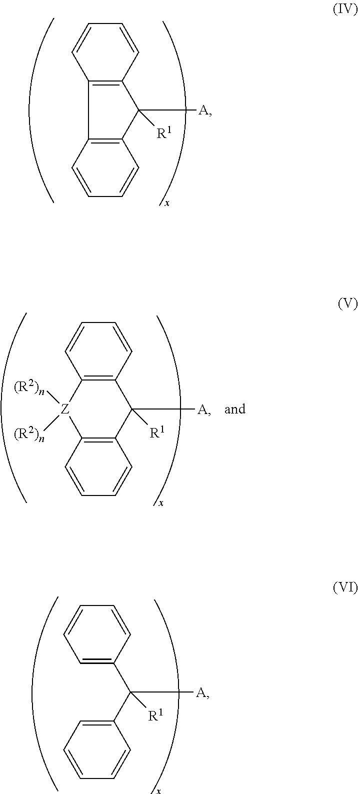

wherein A is a bond, an alkyl, an aryl, or an arene moiety having a molecular weight less than about 10,000 g/mol; wherein R1, R2, and R3 are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

In such an embodiment of the composition the at least one crosslinking compound may be present in the composition in an amount of about 1% by weight to about 50% by weight of an unfilled weight of the composition. Further, a weight ratio of the total weight of the crosslinkable aromatic polymers to the crosslinking compound in the composition is about 1:1 to about 100:1. The composition may optionally further comprise a crosslinking reaction additive, e.g., a reaction control additive, selected from a cure inhibitor or a cure accelerator.

The first crosslinkable aromatic polymer, the second crosslinkable aromatic polymer or both of the first and the second crosslinkable polymers are self-crosslinkable, thermally crosslinkable, chemically crosslinkable or thermally and chemically crosslinkable.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic representation of preferred embodiments of the method according to the invention including variations in the coating apparatus in the process;

FIG. 2 is a graphical representation of the relationship of storage permittivity versus temperature for the PEEK and crosslinked PEEK from Example 1 herein;

FIG. 3 is a graphical representation of the relationship of the dielectric loss tangent versus temperature for the PEEK and crosslinked PEEK from Example 1 herein;

FIG. 4 is a graphical representation of the effect of the content of PPS when incorporated into a PPS/PEEK blend as expressed by plotting the crossover time against the weight percentage of PPS in the blend of Example 6 herein; and

FIG. 5 is a graphical representation of Storage Modulus G′ (measured in Pa).

### DETAILED DESCRIPTION OF THE INVENTION

The present invention includes a method of coating an insulation component with a composition that includes a crosslinked aromatic polymer. The method provides coatings using such compositions for use in high temperature, high voltage, harsh and/or corrosive environments. Compositions for forming coatings according to the method as well as end uses thereof are further described herein.

In the inventions herein, a composition is employed including at least one crosslinkable aromatic polymer. The composition is provided for use in the method, and is heat processed to form a coating of the composition which is applied to the exterior surface of an insulation component. The compositions and coatings formed using the same as well as the method herein provide advantages over non-crosslinkable aromatic polymers for use in insulation components and as an insulation material with respect to mechanical, insulation and wear properties, while maintaining comparable ductility to that of non-crosslinkable materials.

In the method, a coating of the composition is applied to the exterior surface of an insulation component. The aromatic polymer in the composition is crosslinked to provide a coated insulation component. The coating may be an exterior layer or tubular coating (such as a coating on a wire or cable) or may be a partial or complete encapsulation of an insulation component which may be uncoated or already coated with an intermediate layer(s). The coating of the composition applied by the method can be provided to various substrate surfaces such as surfaces including metal, metal alloys, glass, ceramic, polymeric and composite materials.

The invention also includes insulation components formed according to the method and a composition for coating an insulation component including blends of two different crosslinkable aromatic polymers which different also with respect to at least one reaction kinetics property such as crosslinking reaction, a crosslinking reaction rate, and a thermal property. The amount of the crosslinkable aromatic polymers in the blend can be used to adjust the crosslinking reaction rate to provide properties for melt processing, post-cure and other processing treatments.

As discussed further below, the crosslinking of the crosslinkable aromatic polymer(s) may be initiated and/or completed before, during and/or after the coating of the insulation component depending upon the equipment used and the process conditions employed. In one embodiment, crosslinking occurs generally simultaneously with coating of the insulation component. Crosslinking may occur with some polymers from application of heat. A self-crosslinking aromatic polymer may be used or aromatic polymers crosslinkable chemically and/or thermally as described below may be used. In embodiments herein, at least some crosslinking preferably occurs during the coating process, and the crosslinking may continue after applying the coating through further heating, irradiation, and the like. Post-curing is also contemplated herein.

The compositions herein include one or more crosslinkable aromatic polymer(s). The crosslinkable aromatic polymer(s) herein may be any of a variety of cross-linked aromatic polymers. In preferred embodiments, the crosslinkable aromatic polymer(s) are polyarylene polymers, such as a polyarylene ethers (PAE), polyarylene ketones (PAK) or polyarylene ether ketones (PAEK) and various co-polymers thereof known or to be develop in the art. The aromatic polymer compositions include an aromatic polymer that can be crosslinked and may optionally include at least one crosslinking compound.

The crosslinking of crosslinkable, aromatic polymers herein is preferably achieved either by modification of the polymer for grafted crosslinking and then exposing the aromatic polymer to sufficiently high temperatures to induce self-crosslinking of the polymer and/or by use of a crosslinkable aromatic polymer with the use of one or more separate crosslinking compound(s).

The aromatic polymer may be crosslinked, for example, by grafting functional groups onto the polymer backbone which can be thermally induced to crosslink the polymers, as further described in U.S. Pat. No. 6,060,170, incorporated in relevant part herein by reference. Alternatively, the crosslinkable aromatic polymer may be crosslinked by thermal action at temperatures greater than about 350° C. or more, as disclosed in U.S. Pat. No. 5,658,994, incorporated herein, in relevant part, by reference. An example of a preferred material for use in thermal crosslinking is 1,2,4,5 tetra(phenylethynyl)benzene as shown below

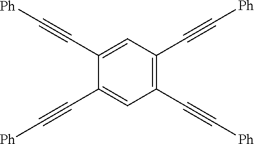 [SMILES: C(#Cc1cc(C#Cc2ccccc2)c(C#Cc2ccccc2)cc1C#Cc1ccccc1)c1ccccc1]

In a preferred embodiment of the present application, the crosslinkable polymer compositions of the present invention include an aromatic polymer and at least one crosslinking compound capable of crosslinking the aromatic polymer either across chains or to itself within the polymer matrix. Such polymers may include through polymerization or through functionalization groups that enable self-crosslinking. Grafted crosslinking may also be used, provided that the polymer formed is capable of being processable within a coating form, such as by solvent casting or melt processing.

The crosslinkable aromatic polymer of the compositions used in the method may be any of a variety of polyarylene homopolymers or copolymers, including polyarylene ethers and/or polyarylene ketones, such as polyetherketone (PEK), polyetherketone ketone (PEKK), polyetherether ketone (PEEK), polyetherdiephenylether ketone (PEDEK) and the like; polysulfones (PSU); polyethersulfones (PES); polyphenylene sulfides (PPS); polyphenylene oxides (PPO); polyphenylsulfones (PPSU); polyimides (PI); polyetherimides (PEI) and thermoplastic polyimides (TPI); polybenzamides (PBA); polyamide-imides (PAI); aromatic polyureas; polyurethanes (PU); polyphthalamides (PPA); polybenzimidazoles (PBI); polyaramids or similar aromatic polymers known in the art or to be developed including various copolymers and functionalized or derivatized versions of such polymers. Examples of various polyketones and polysulfone homopolymers and copolymers that are amenable to the method described herein are outlined in McGrail, “Polyaromatics,” Polymer International 41 (1996), pp. 103-120.

The crosslinkable aromatic polymer(s) may be functionalized or non-functionalized as desired to achieve specific properties or as necessary for specific applications, e.g., functional groups such as hydroxyl, mercapto, amine, amide, ether, ester, halogen, sulfonyl, aryl and functional aryl groups or other functional groups can be provided depending intended end effects and properties. The aromatic polymer can also be a polymer blend, alloy, or co-polymer or other multiple monomer polymerization of two or more of such aromatic polymers, provided one is crosslinkable. Preferably, when the aromatic polymer is a blend or alloy, the aromatic polymers are chosen so as to be processible at in a compatible processing temperature range.

In an embodiment of the method, in the composition used for coating therein, the crosslinkable aromatic polymer(s) may be a poly(arylene ether) including polymer repeating units along its backbone having a structure according to formula (I):

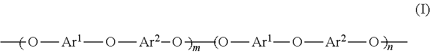

wherein Ar¹, Ar², Ar³ and Ar⁴ may be identical or different aryl radicals, m=0 to 1, and n=1-m, wherein such polymers may be of a variety of molecular weights and chain lengths depending on intended end use as is known in the relevant aromatic polymer art. Ar radicals in Formula (I) include but are not limited to biphenyl, terphenyl, Lanthracene, naphthyl, and other polyaromatic moieties. Larger aryl structures are known in the art in order to increase Tg so that polymers may be selected or modified to be more suitable as a polymer or copolymer structure depending on the end application service temperature. See, McGrail, as noted above.

In a further embodiment, the crosslinkable aromatic polymer(s) may be a poly(arylene ether) as in formula (I), wherein m is 1 and n is 0, and the aromatic polymer has repeating units along its backbone having a structure as shown below in formula (II):

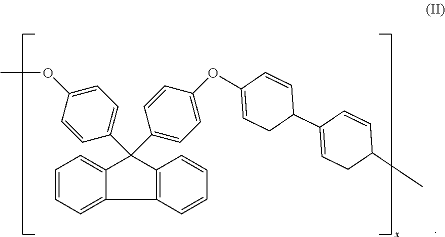

Such polymers may be obtained commercially for example, as Ultura™ from Greene, Tweed, Kulpsville, Pa.

In preferred embodiments, the crosslinkable aromatic polymer(s) are one or more of polyaryletherketones (PAEK), including polyetherketone (PEK), polyetheretherketone (PEEK), polyetherketoneketone (PEKK), polyetherdiphenylether ketone (PEDEK) and polyetherketoneetherketoneketone (PEKEKK). The crosslinkable aromatic polymer may be a commercially available crosslinkable aromatic polymer as noted above. PAEKs for use in the invention are commercially available, for example as PEEK under the name Victrex™ PEEK, available from Victrex, plc; KetaSpire® PEEK from Solvay, and Vestakeep® from Evonik. Suitable copolymers of such materials including ketone and/or sulfones and other biphenyl, diphenyl and triphenyl derivatives may also be used.

In an embodiment herein in which an optional crosslinking compound(s) is/are used, such crosslinking compounds may be any such compounds which can initiate chemical crosslinking of aromatic polymers. A preferred crosslinking compound for use with the crosslinkable aromatic polymers is described in applicant's U.S. Pat. No. 9,006,353, incorporated herein by reference, in relevant part. Such a crosslinking compound is of the general structure:

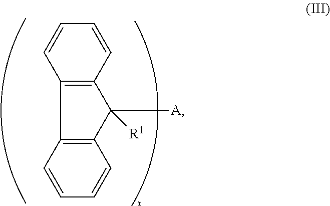

wherein R is OH, NH₂, halide, ester, amine, ether or amide, and x is 1 to 6 and A is an arene moiety having a molecular weight of less than about 10,000 g/mol. When reacted with an aromatic polymer, such as a polyarylene ketone, such crosslinking compound forms a thermally stable, cross-linked oligomer or polymer.

Such crosslinking technology enabled aromatic polymers, that were believed in the art to be difficult to crosslink, to be formed in a crosslinkable form so as to be thermally stable up to temperatures greater than 260° C. and even greater than 400° C. or more, depending on the polymer so modified, i.e., polysulfones, polyimides, polyamides, polyetherketones and other polyarylene ketones, polyphenylene sulfides, polyureas, polyurethanes, polyphthalamides, polyamide-imides, aramids, and polybenzimidazoles.

Additional crosslinking compounds for crosslinking aromatic polymers include one or more of the crosslinking compounds according to any of the following structures:

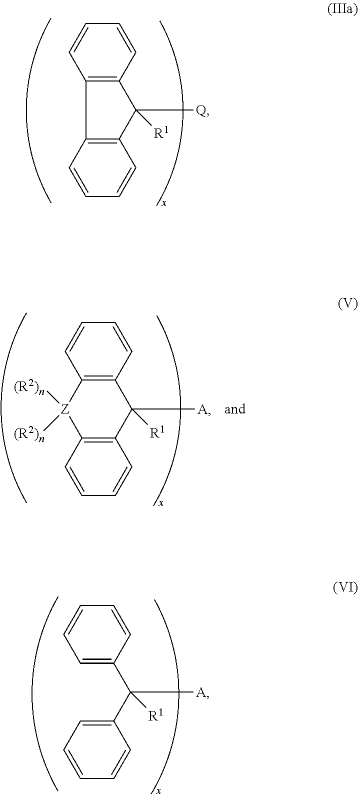

wherein Q is a bond and A may be Q, an alkyl, an aryl, or an arene moiety having a molecular weight less than about 10,000 g/mol. Each of R¹, R², and R³ may be the same or different and may be independently selected from the group consisting of hydrogen, hydroxyl (—OH), amine (—NH₂), halide, ester, ether, amide, aryl, arene, or a branched or straight chain, saturated or unsaturated alkyl group, preferably of one to about six carbon atoms. Formula (IIIa) is substantially the same as formula (III) above, with the exception that the moiety A in formula (III) is replaced by Q (which represents a bond) and R¹ of formula (IIIa) is defined differently than R of formula (III).

In formula (V), m is preferably from 0 to 2, n is preferably from 0 to 2, and m+n is greater than or equal to zero and less than or equal to two. Further, in formula (V), Z is preferably selected from the group of oxygen, sulfur, nitrogen, and a branched or straight chain, saturated or unsaturated alkyl group of one to about six carbon atoms. In any of formulae (IIIa), (V) and (VI), as with formula (III), x is also about 1 to about 6.

The compositions used in the method of the present invention may include a blend of one or more crosslinking compounds. In another embodiment, the composition may include a single crosslinking compound that can be selected based upon the aromatic polymer of the crosslinkable polymer composition.

In a further embodiment, the crosslinking compound of the crosslinkable polymer composition of the present invention has a structure according to one of the following formulae:

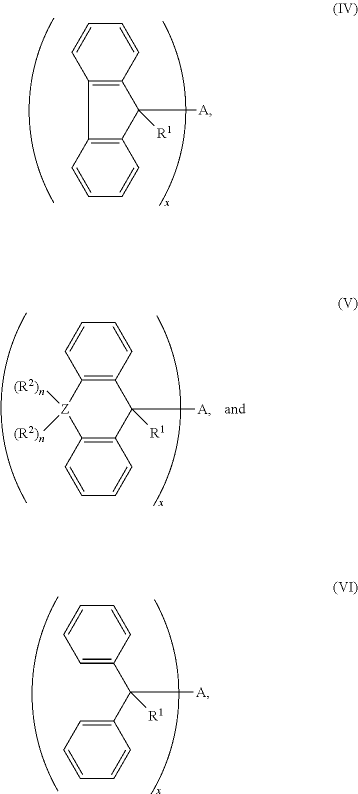

In each of formulae (IV)-(VI), A may be a bond, an alkyl, an aryl, or an arene moiety preferably having a molecular weight less than about 10,000 g/mol. A molecular weight of less than about 10,000 g/mol permits the overall structure to be more miscible with the aromatic polymer, and permits uniform distribution, with few or no domains, within the composition including the aromatic polymer and crosslinking compound. More preferably, A has a molecular weight from about 1,000 g/mol to about 9,000 g/mol. Most preferably, A has a molecular weight from about 2,000 g/mol to about 7,000 g/mol.

The moiety A may be varied to have different structures, including, but not limited to the following:

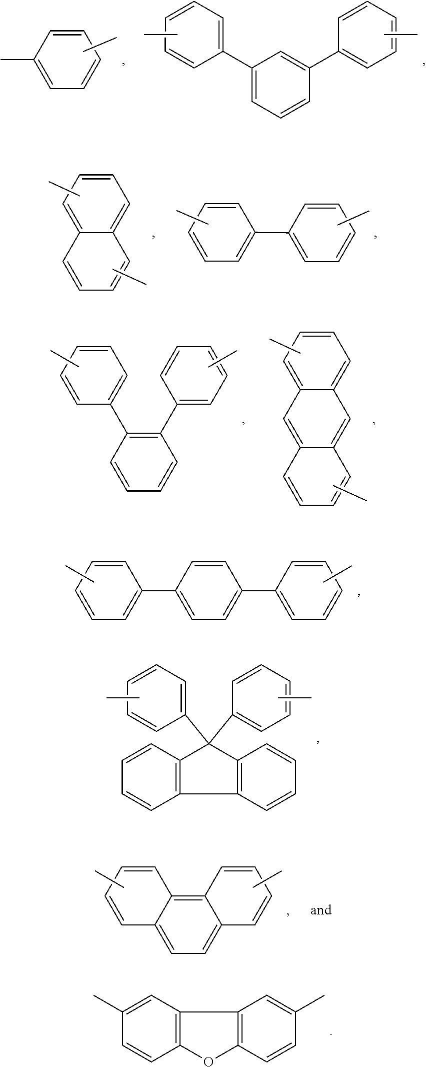

Further, the moiety A may be functionalized, if desired, using one or more functional groups such as, e.g., and without limitation, sulfate, phosphate, hydroxyl, carbonyl, ester, halide or mercapto or the other functional groups noted above.

In formulas (IV) and (VI), R¹ is preferably selected from the group consisting of hydrogen, hydroxyl (—OH), amine (NH₂), halide, ester, ether, amide, aryl, arene, or a branched or straight chain, saturated or unsaturated alkyl group of preferably one to about six carbon atoms.

In formula (V), R¹, R², and R³ may be the same or different and are preferably independently selected from the group consisting of hydrogen, hydroxyl (—OH), amine (NH₂), halide, ester, ether, amide, aryl, arene, or a branched or straight chain, saturated or unsaturated alkyl group of preferably one to about six carbon atoms. Thus, R¹, R², and R³ may each be different, two of R¹, R², and R³ may be the same with the third being different, or each of R¹, R², and R³ may be the same. Further, in formula (V), m is preferably from 0 to 2, n is preferably from 0 to 2, and m+n is preferably greater than or equal to zero and less than or equal to two. Thus, in formula (V), one or two R² groups may be present, one or two R³ groups may be present, one R² group and one R³ group may be present, or R² and R³ may both be absent. In formula (V), Z is preferably selected from the group of oxygen, sulfur, nitrogen, and a branched or straight chain, saturated or unsaturated alkyl group of one to about six carbon atoms. In any of formulas (IV)-(VI), x is preferably about 1 to about 6.

In embodiments having a crosslinking compound according to formula (IV), the crosslinking compound may have a structure according to one or more of the following:

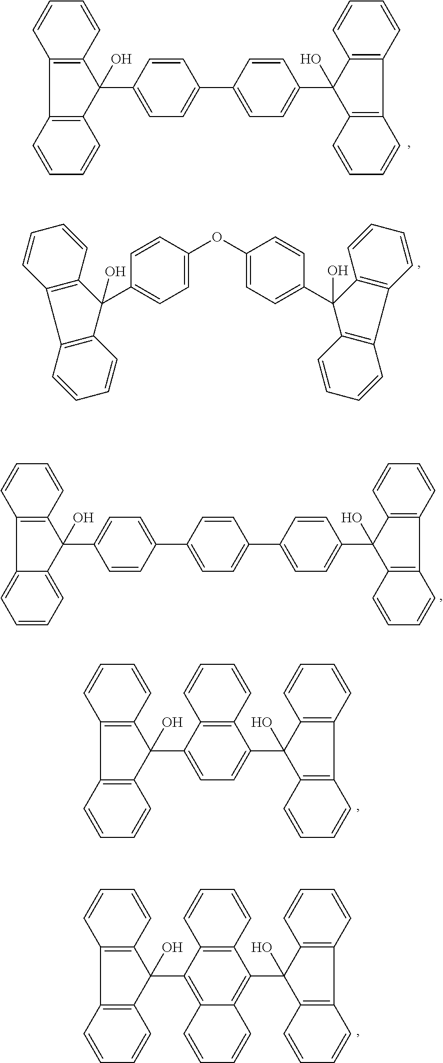 [SMILES: OC1(c2ccc(-c3ccc(C4(O)c5ccccc5-c5ccccc54)cc3)cc2)c2ccccc2-c2ccccc21 ; OC1(c2ccc(Oc3ccc(C4(O)c5ccccc5-c5ccccc54)cc3)cc2)c2ccccc2-c2ccccc21 ; OC1(c2ccc(-c3ccc(-c4ccc(C5(O)c6ccccc6-c6ccccc65)cc4)cc3)cc2)c2ccccc2-c2ccccc21 ; OC1(c2ccc(C3(O)c4ccccc4-c4ccccc43)c3ccccc23)c2ccccc2-c2ccccc21 ; OC1(c2c3ccccc3c(C3(O)c4ccccc4-c4ccccc43)c3ccccc23)c2ccccc2-c2ccccc21]

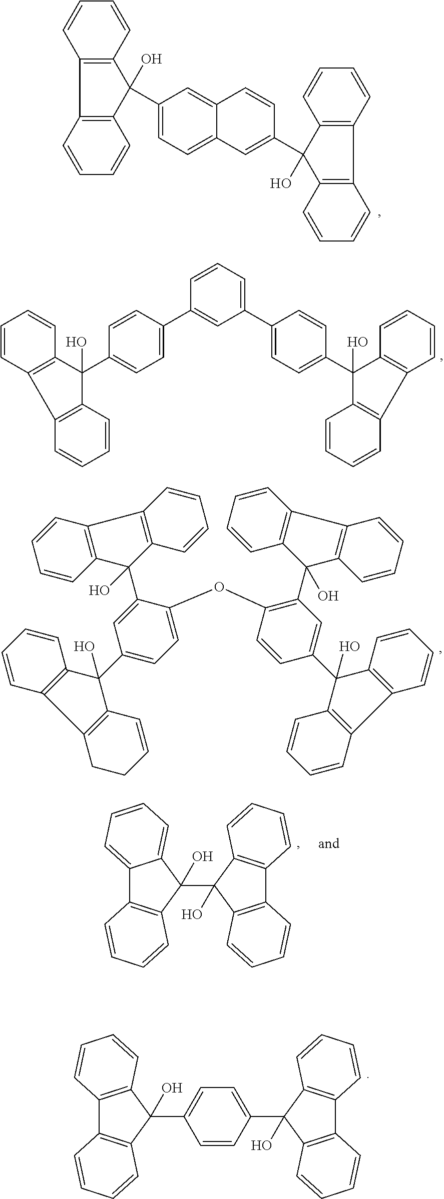

The above-listed crosslinking compounds are not intended to be limiting and are merely provided as examples of crosslinking compounds according to formula (IV). In the above crosslinking compounds of formula (IV), R¹ is shown as being a hydroxyl group. The moiety, A, is shown as being any of various aryl groups, and x is shown as being either 2 or 4.

In embodiments having a crosslinking compound of formula (V), the crosslinking compound may have a structure according to one or more of the following:

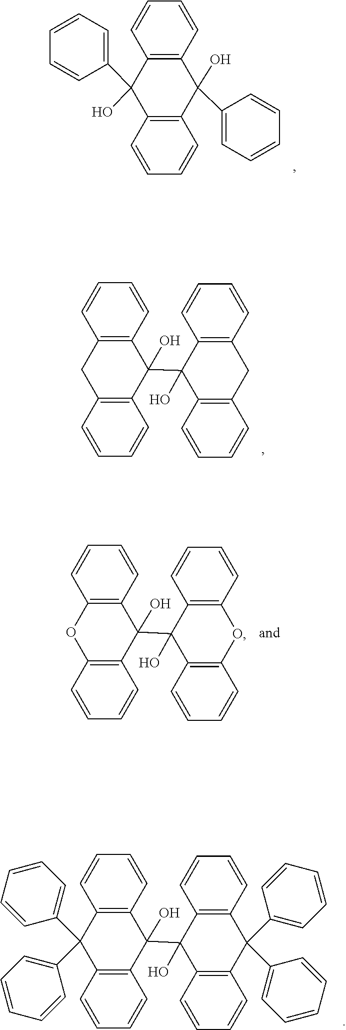 [SMILES: OC1(c2ccccc2)c2ccccc2C(O)(c2ccccc2)c2ccccc21 ; OC1(C2(O)c3ccccc3Cc3ccccc32)c2ccccc2Cc2ccccc21 ; OC1(C2(O)c3ccccc3Oc3ccccc32)c2ccccc2Oc2ccccc21 ; OC1(C2(O)c3ccccc3C(c3ccccc3)(c3ccccc3)c3ccccc32)c2ccccc2C(c2ccccc2)(c2ccccc2)c2ccccc21]

The above-listed crosslinking compounds are not intended to be limiting and are merely provided as examples of crosslinking compounds according to formula (V). In the above crosslinking compounds of formula (V), Z is shown as being an alkyl group with one carbon atom or O. R¹ is shown as being a hydroxyl group. R¹ and R³ are shown as being the same, different or not present. The moiety A is shown as being a bond or an aryl group. Further, x is shown as being 1 or 2.

In embodiments in which the crosslinking compound has a structure according to formula (VI), the crosslinking compound may have one or more of the following structures:

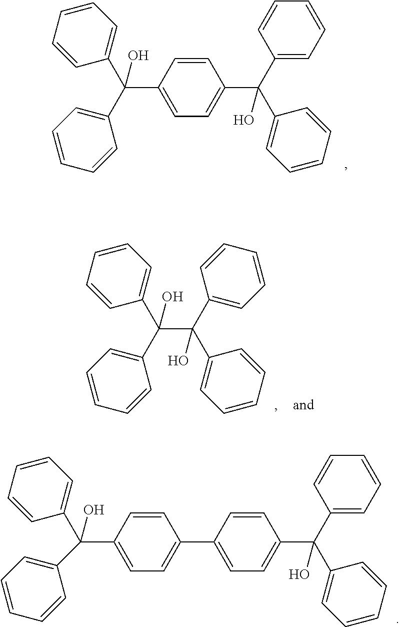 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

The above-listed crosslinking compounds are not intended to be limiting and are merely provided as examples of crosslinking compounds according to formula (VI). In the above compounds of formula (VI), R¹ is shown as a hydroxyl group. The moiety A is shown as being a bond or an aryl group. Further, x is shown as being 2.

The amount of crosslinking compound(s) for use with the crosslinkable aromatic polymer in the composition used in the methods herein is/are (collectively) preferably about 1% by weight to about 50% by weight, 5% by weight to about 30% by weight or about 10% to about 35%, or about 8% by weight to about 24% by weight based on the total weight of an unfilled composition of the crosslinkable aromatic polymer and the crosslinking compound.

The compositions used in the present method may have a weight ratio of the crosslinkable aromatic polymer to the crosslinking compound that is preferably about 1:1 to about 100:1. More preferably, the weight ratio of the aromatic crosslinkable polymer to the crosslinking compound in the composition is about 3:1 to about 10:1.

The compositions may optionally further include a crosslinking reaction additive for controlling the cure reaction rate during melt processing and post-treatment. Such an additive may be mixed in at varying stages of the method depending upon the cross-linking speed and density desired to achieve the coated insulation component, and for continuous methods, also dependent upon the coating process speed. The use of a crosslinking reaction control additive for controlling cure reaction rate, i.e., crosslinking rate and extent, will also depend upon the cure reaction kinetics of a particular aromatic polymer and the crosslinking compound used. Thus the crosslinking reaction control additive included can be a cure inhibitor (a Lewis base agent), such as lithium acetate for reactions with a high reaction rate, or the crosslinking reaction additive may be a cure accelerator (a Lewis acid agent) when the cure reaction rate is too slow, such as magnesium chloride or other rare earth metal halides. When the composition includes a crosslinking reaction control additive, the amount of crosslinking reaction control additive in the composition is preferably about 0.01% to about 5% by weight based on the weight of the crosslinking compound, but may be adjusted depending on the reaction rate achieved in a given system.

The above compositions may be formed to have blends of crosslinkable aromatic polymers in the composition. Such blends include two or more such polymers. However, the blends may be used as an alternative path towards controlling the crosslinking of the composition during the method and coating process. Providing control to the reaction allows for it to occur earlier or later in the process giving a variety of options to a manufacturer providing coatings in terms of strength and other desired properties, coating thickness and consistency in properties.

In the method two or more crosslinkable aromatic polymers such as those noted above may form a blend. The two polymers (first and second polymers) are in such case preferably two different polymers, each differing from the other regarding some aspect of its reaction kinetics, i.e., each preferably has at least one reaction kinetics property that is different from the other. If there are more than two such crosslinkable aromatic polymers in the blend, than at least two of them should be different in this aspect(s). The at least one reaction kinetics property may be, e.g., the nature of the crosslinking reaction, the crosslinking reaction rate, and/or a thermal property, and any other properties associated with the crosslinking that alters the speed or progression rate of the reaction itself. In a preferred embodiment, the reaction kinetics property that most typically is useful for varying the crosslinkable aromatic polymers in the blend is the crosslinking reaction rate.

Such blends may be formed from any of the above-noted polymers described herein. Examples of suitable blends including polyphenylene sulfide and polyetherether ketone; polyphenylene oxide and polyphenylene sulfide; and polyetherimide and polyphenylene sulfide.

If the first crosslinkable aromatic polymer in the blend is one that has a crosslinking reaction rate that is slower than the second or different crosslinkable aromatic polymer in the blend, then in one preferred embodiment the first crosslinkable polymer may be of a type with a slower crosslinking rate, such as polyphenylene sulfide or other similar polymers where the crosslinking rate is also slow. In such an embodiment, a faster crosslinking polymer may be the different, or second crosslinkable aromatic polymer such as one or more polyarylenes selected from polyetherketone, polyetheretherketone, polyetherdiephenylether ketone, polyetherketone ketone, and blends, co-polymers and alloys thereof; one or more polysulfone, polyphenylsulfone, polyethersulfone, and co-polymers and allows thereof; and one or more of polyimide, thermoplastic polyimide, polyetherimide, and blends, co-polymers and allows thereof. Copolymers and blends of these materials may also be used, as well as providing functional groups to the polymers if desired to facilitate crosslinking using techniques known in the art.

The blends may further preferably comprise at least two polymers that are of different reaction kinetics (e.g., different reactions, reaction rates, thermal properties, reactivity and the like) to assist in controlling a crosslinking reaction rate without adding a crosslinking reaction additive, such as those mentioned above. When one of the polymers in the blend has a slower crosslinking reaction rate it can be added to one or more other polymers with faster crosslinking rates to reduce the overall crosslinking rate in the blend. Thus, when working with faster crosslinking polymers, the composition may be blended to incorporate the crosslinking slower reaction rate of the first crosslinkable aromatic polymer into the second crosslinkable aromatic polymer. The slower crosslinkable aromatic polymer is preferably added in an amount of about 1 to about 50 percent by weight based on the total weight of the first and the second crosslinkable aromatic polymers. This provides a degree of crosslinking for the blend that it optimal and facilitates melt processing and post-curing of the blend.

Alternatively, in the method, the reverse may also be done by modifying compositions based on slower curing aromatic crosslinkable polymers with faster crosslinking crosslinkable aromatic polymers to accelerate the crosslinking reaction rate of the first crosslinkable aromatic polymer using addition of the second crosslinkable aromatic polymer with different crosslinking reaction rate into the blend. The faster crosslinkable aromatic polymer may be added to the slower crosslinkable aromatic polymer in an amount that is about 1 to about 50 percent by weight based on the total weight of the first and the second crosslinkable aromatic polymers. In this manner the same composition may also be modified by blending to provide a degree of crosslinking for the blend that facilitates melt processing and post-curing of the blend.

In this embodiment, by using optionally such blends wherein two crosslinkable aromatic polymers are used with differing cure reaction kinetics, the blends themselves can act to control the crosslinking or curing reaction rate during melt processing and post-treatment without the need to incorporate cure control additives such as those noted above. The blends may be mixed in varying stages of the method depending upon the cross-linking speed and density desired to achive the coated insulation component. For continuous methods, this may also be dependent upon the coating process speed. The use of such blends for controlling crosslinking reaction rates and the extent of crosslinking to be provided, will depend on the cure reaction kinetics of the paritcular aromatic polymer components and whether, and what kind of, aromatic crosslinkable polymers are chosen. To accelerate the cure reaction of a slower reaction polymer, a faster reaction polymer may be added to a slower reaction polymer. For example, PAEK may be incorporated into PPS. The same may be done in reverse as noted above.

When using the blends, if the aromatic polymers therein are self-crosslinkable and/or many be thermally crosslinked, a crosslinking compound is not required. However, in preferred embodiments hereof crosslinking compounds such as those described herein may be employed in the composition. As the blends can accelerate or slow down the crosslinking reaction speed, an additional reaction control additive as noted above is further not necessary even if the crosslinking compound is employed. However, if desired, one of skill in the art could still employ such control additives to fine tune the rate.

The composition of the methods herein may further be filled or reinforced with one or more additives to improve the modulus, impact strength, wear or tribology properties, bonding strength, dimensional stability, heat resistance and electrical properties of insulation components and other articles formed using the compositions in the methods herein. Preferably, the additive is selected from one or more of continuous or discontinuous, long or short, reinforcing fibers selected from one or more of carbon fibers, glass fibers, woven glass fibers, woven carbon fibers, aramid fibers, boron fibers, polytetrafluoroethylene (PTFE) fibers, ceramic fibers, polyamide fibers, and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, borax (sodium borax), activated carbon, pearlite, zinc terephthalate, graphite, graphene, talc, mica, silicon carbide whiskers or platelets, nanofillers, molybdenum disulfide, fluoropolymer fillers, carbon nanotubes and fullerene tubes.

Additives may also be chosen in order to assist in modifying the coefficient of thermal expansion (CTE). As preferred insulation components can include metallic materials which tend to have a low CTE, and coatings herein may include crosslinkable or crosslinked aromatic polymers with a higher CTE, such differences in CTE could have an impact on bonding adhesion between the coating and the insulation component surface, particularly in direct coatings. Thus, this impact may be mitigated by inclusion of fillers that would reduce the CTE of the polymer in the compositions used in the methods herein, e.g., glass fibers, milled glass, glass beads, mica, aluminum oxide and/or talc.

The additives may additionally or alternatively include other thermal management fillers, including but not limited to nanodiamonds and other carbon allotropes, polyhedral oligomeric silsesquioxane (“POSS”) and variants thereof, silicon oxides, boron nitrides, and aluminum oxides. The additives may additionally or alternatively include flow modifiers, such as ionic or non-ionic chemicals.

The additive preferably includes an optional CTE-reducing additive as noted above and/or an optional reinforcing fiber which is a continuous or discontinuous, long or short fiber, that is carbon fiber, PTFE fiber, and/or glass fiber. Most preferably, the additive is a reinforcing fiber that is a continuous, long fiber. The crosslinkable polymer composition comprises about 0.5% to about 65% by weight of additives in the composition, and more preferably about 5% to about 40% by weight of additives in the composition. The crosslinkable polymer composition may further comprise one or more of stabilizers, tribological or rheological adjustment additives, flame retardants, pigments, colorants, plasticizers, surfactants, or dispersants.

The composition may be prepared by providing the crosslinkable aromatic polymer(s) and optionally a crosslinking compound capable of crosslinking the aromatic polymer(s) and combining the aromatic polymer and the crosslinking compound. If self-crosslinkable polymers or grafted polymers are used, the crosslinking compound may be omitted. If the crosslinking compound is used in the composition it is preferably combined with the aromatic polymer to form a preferably substantially homogeneous composition.

Incorporation of the crosslinking compound(s) into the crosslinkable aromatic polymer(s) can be performed by various methods, such as by solvent precipitation, mechanical blending or melt blending. Preferably, the crosslinkable polymer composition is formed by dry powder blending of the crosslinking compound and aromatic polymer, such as by conventional non-crosslinked polymer compounding processes, including, for example, twin-screw compounding. The resulting composition can be extruded into filaments or can be used as a powder or pellets for use in the method herein.

Blending (including blending of more than one crosslinkable aromatic polymer) may be accomplished further by use of an extruder, such as a twin-screw extruder, a ball mill, or a cryogrinder. Blending of the crosslinkable aromatic polymer(s) and crosslinking compound(s) is preferably conducted at a temperature during blending that does not exceed about 250° C. so as to preferably avoid premature curing during the blending process. If a melt process is used, care should be taken to ensure thermal history and temperature exposure are minimized, i.e., it is preferred to use short residence times and/or as low temperature as feasible to achieve material flow. Alternatively, use of rate controlling additives as described above and/or the blending of crosslinkable aromatic polymers of differing reaction kinetics, may be used to inhibit curing and/or control the curing rate to minimize any crosslinking due to compounding and conversion into a pellet or fiber form. Depending on the polymer and components selected in the composition, the material may be introduced to an extruder as a powder, fiber, pellet or in some instances, as a liquid. Suitable crosslinking additives are known in the art and are described in U.S. Pat. No. 9,109,080 of the present applicant, which is incorporated herein, in relevant part, with respect to the cross-linking control additives.

As the blending process may be exothermic, it is necessary to control the temperature, which can be adjusted as necessary and to temperatures indicated depending upon the particular crosslinkable aromatic polymer(s) selected for use. In mechanical blending of the aromatic polymer and crosslinking compound, the resulting composition is preferably substantially homogenous in order to obtain uniform crosslinking.

When the composition is prepared, is can be cured by exposure to a temperature greater than 250° C., for example at a temperature of about 250° C. to about 500° C. However, when and to what extent to subject the composition to heat during the coating process will depend upon the final coating thickness and properties to be achieved. For example, greater crosslinking may create higher levels of mechanical strength, but could impact ductility.

With respect to the coating properties, the degree of cross-linking (cross-link density) may be varied or adjusted to provide different coating properties and to avoid potential defects. Cross-link density may be controlled when using compositions having a crosslinking compound by varying the concentration of the crosslinking compound and/or by controlling the amount of any optional crosslinking reactition additive used in conjuction with the crosslinking compound. The extent of cure, i.e., the completion of the crosslinking reaction, is related to both thermal activation of the reaction if driven by changes in temperature, as well as practical concerns involving the rate of cure.

In an embodiment using a blend of two crosslinkable polymers of different kinetics as described herein, the crosslinking rate may be controlled not only by modifying the amount of any cross-compound used, agent also by altering the amount of the slower curing polymer used in the blend.

Control of the crosslinking reaction rate as well as the degree of crosslinking can impact the end products. If the curing (crosslinking) reaction proceeds too rapidly, the resulting coating may experience defects such as bubbling or delamination. Further, as water can be generated from various crosslinking reactions, any such water will need to be diffused through the polymer coating in a controlled manner, to avoid defects such as blistering. Thicker coatings or molded articles are preferably made by controlling the reaction rate to be a longer and slower crosslinking reaction and so are preferably run at lower temperatures. If the coating is to be thinner, such a coating would have a lower diffusion length such that damaging or catastrophic blistering is less likely to occur in thin coatings formed at higher temperatures absent the potential impact of expansion pressure from any formed gas that exceeds the cohesive strength of the coating. To avoid such issues, the process would be carried out so as to minimize and/or control the rate at which gas is generated during cross-linking to minimize associated defects.

The level of crosslinking may also be adjusted for achieving desired mechanical end properties. Generally, higher levels of a crosslinking compound can lead to a stiffer product with less ductility after a full cure cycle. For coating wires or cables that are required to be coiled on spools, a low ductility may result in cracking of the coating. To prepare a coating of this nature, the crosslinking level may be adjusted to enhance ductility. Thinner, more ductile coatings, may be formed by using lower levels of crosslinking compound and/or by modifying the crosslinking reaction rate, for example, by using crosslinking additives with the crosslinking compound. Further, such levels of crosslinking may be modified by adjusting the cure rate through blending crossinkable aromatic polymers of different reaction kinetics. For a thicker, stiffer coating or encapsulation, the crosslinking level would be increased, and the crosslinking compounds and/or additives and/or the amount of blended crosslinkable aromatic polymers may be adjusted to achive the desired increase in crosslinking.

The composition may further be prepared by dissolving both the crosslinkable aromatic polymer and crosslinking compound in a common solvent and removing the common solvent via evaporation or by the addition of a non-solvent to cause precipitation of both the polymer and crosslinking compound from the solvent. For example, depending upon the aromatic polymer and crosslinking compound selected, the common solvent may be tetrahydrofuran, and the non-solvent may be water. An additional option for polymers and crosslink additives that are soluble in the same solvent is the use of solvent casting or dip coating of the substrate. In that case, the crosslinkable polymer(s) and any crosslinking compounds and/or additives would be dissolved in a suitable solvent and then applied to a wire or other insulation component to be coated. The solvent would be removed in a controlled manner, and the uncured coating could then be cured using various techniques such as application of heat or radiation, and/or by chemically induced cross-linking.

In preparing the composition, it is preferred that any optional additives are added to the composition along with or at the same time the crosslinking compound is combined with the crosslinkable aromatic polymer(s) to make the crosslinkable polymer composition. However, the specific manner of providing reinforcing fibers or fillers may be according to various techniques for incorporating such materials and should not be considered to limit the scope of the invention.

Once the composition is prepared, to form a coated and/or encapsulated insulation component, the composition is heat processed and applied as a coating on an exterior surface of an insulation component. It is to be noted that where an insulation component has a structure that allows for coating of an interior facing portion of its exterior surface, such as in a porous stucture or structure with surface features, the exterior surface would include areas of coating on such surface even if they extend within the component.

The insulation components herein may be of a variety of types, including cable, wire, fiber optic cables, hybrid cables, individual fibers and other insulation devices and components would be used particularly in end applications that experience high temperatures, high voltage, and/or harsh and/or corrosive chemical environments in the downhole drilling and oil and gas industries, in aerospace industries and in chemical processing, including as might be encountered in downhole tooling, as well as motors, magnets, submersible pumps, telemetry cables for logging and measuring while drilling and in other operations where sensors are used to measure conditions downhole or in other remote locations. Further, such components include those used in devices that are connected by wire(s) and/or cables wherein a signal must be transmitted from a sensor in a working environment through the wire or cables to a measuring or logging equipment, and where accuracy and performance are important. Such wires and cables may also be used in aerospace components and in fluid handling components.

While layered extrusion or co-extrusion techniques may be made for standard planar surfaces or injection molding may be used for specific shapes, or additive manufacturing may be used as described in applicant's International Patent Publication No. WO 2020/056052 A1, when coating long insulation components such as wires and cables, the composition including the crosslinkable aromatic polymer is preferably extruded over the elongated insulation component. A preferred method for such coating is described below using a composition that is a crosslinkable polyaryletherketone, available commercially as Arlon® 3000XT.

To coat a long substrate like a wire, one preferred method for coating involves applying the coating by extruding the composition using techniques currently used for wire coating of non-crosslinked materials, but adjusting the parameters to accommodate the crosslinking reaction. Extruders used for non-crosslinked wire coating materials including non-crosslinked polyarylenes, generally employ a cross-head die. In addition, in the method herein, downstream and cooling equipment is desired, such as a heating tunnel and/or a cooling bath.

In alternative examples of methods that may be used, aside from an extruder, the coating step may be carried out using a fluidized bed coating process employing a powdered polymer composition to coat the substrate passing through the fluidized bed, or a fluidized bed incorporating such a powdered polymer composition may be used also to coat a substrate by feeding the contents of the fluidized bed to a spray coating device, such as a thermal sprayer or electrostatic sprayer (for example, using a plasma arc or corona discharge) to apply the composition on the substrate, such as in a spraying booth.

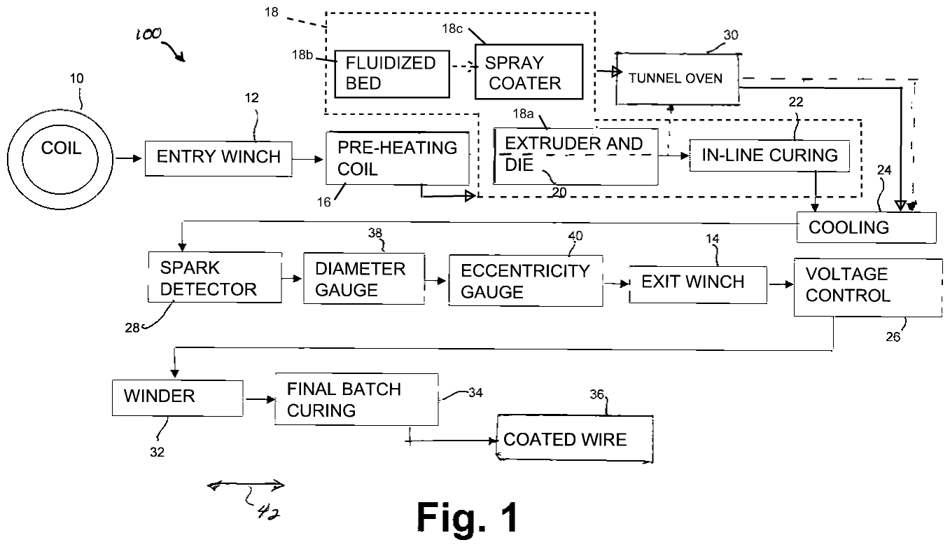

As wire is pulled through the process, regardless of the coating apparatus used, wire spools and winders are preferably employed in the overall process configuration. With reference to FIG. 1, in an illustration of such a process, a substrate insulation component such as a coil of wire 10 may be fed through a feeder such as an entry winch 12 into the process. Such components are readily available in the relevant art for extruding both thermoplastic and thermoset materials, and may be adapted in the present method. Information on methods used in the art to extrude, or otherwise coat using a fluidized bed and/or a spraying apparatus to apply non-crosslinked polyarylenes may be found, for example, in the Processing Guide and Extrusion Molding Guide for Victrex® polyaryletherketone products available and the Vicote™ Coatings, High Temperature Performance Coatings for Strength and Durability, both of which are available at www.vixtrex.com, and each of which is incorporated herein by reference in relevant part. Such prior art techniques can include extrusion of PEEK over wire and cooling of the extrudate over wire and cable.

Thermoset silicone materials are processed to form medical tubing and braided hose using commercial techniques that employ radiant heating and use of infrared light. Such techniques as are known, e.g., for processing uncrosslinked PEEK and for processing curable silicone, can be used for crosslinkable aromatic compounds when extruding over a wire, cable or other extended length insulation component.

In adapting such equipment for coating insulation components using compositions of crosslinkable aromatic polymer(s), the settings and heat profiles may be adjusted so that the crosslinkable aromatic polymer(s) may cure before, during or after the coating process, the conditions need to be adjusted to take into account the crosslinking reaction, and the resulting mechanical and coating properties desired.

With reference to FIG. 1, the coil may be pre-heated in a pre-heating step 16 in a pre-heating mechanism (in-line oven or other source) prior to entry into a coating apparatus 18, such as an extruder 18a in fluid process communication with a die 20, a fluidized bed 18b, or a fluidized bed in combination with an electrostatic or thermal spray coating device in a spray booth 18c. Any of these coating apparatuses or other coating apparatuses known or to be developed in the art for use with aromatic polymers may be used herein.

If the coating apparatus 18 is an extruder, throughput and temperature profile is first preferably selected that will optimize the curing reaction for the particular chemical process that is selected in curing the crosslinkable aromatic polymer(s). In one embodiment, herein, some or all of the curing may occur in batches after an initial extrusion coating is applied. In another embodiment herein, an oven length may be selected that will allow for continuous in-line curing in an optional in-line curing step 22 and/or increasing in-line post curing of the material depending on the desire to expedite curing for a particular crosslinkable aromatic polymer or blend thereof. Alternatively, or in addition to in-line curing in step 22, a tunnel oven 30 may be provided to curing.

The cure profile of the crosslinkable aromatic polymer(s) should be known for evaluating the method extrusion or heat processing conditions to be employed. Thus, knowing the onset of cure, the cure reaction time and kinetics allow for temperature curve calculations to be modeled for a given heat process.

Due to the impact of the cure process, a single screw extruder may be used, and if so, a preferred extruder L/D is at least about 15:1 to about 25:1, and more preferably about 18:1 to about 25:1. The extruder barrel temperature may be varied as noted above, but in one preferred embodiment, may be about 650° F. to about 700° F. A lower barrel temperature will generally slow the crosslinking reaction and improve processing. Compression ratios are also preferably low to avoid frictional and heat generation in processing other than the heating that is applied for the specific purpose and curing. The lowering of the compression ratios will help suppress unwanted heat source generation (such as heat of friction).

The residence time may be calculated based on the cure profiles (cross-over time and time to full cure) of the particular crosslinkable aromatic polymer(s) being processed, and taking into account the process speed with which a long profile insulation component such as a wire or cable is pulled through the process. Such long components may be fed by rolls or reels and the component pulled through a heat processing equipment such as a die 20 which may be a cross-head die. The extruded crosslinkable aromatic polymer(s) is/are also fed into the same cross-head die (in a manner as used in the prior art for non-crosslinked materials), but at speeds and temperatures to avoid, if desired, unwanted heat of friction. The line speed can be adjusted as is known in the art for the coating thickness and taking into account the curing residence times. In a preferred embodiment, the extruder 18 is positioned so as to extend perpendicularly to the general process direction as shown with respect to the arrow 42 in FIG. 1.

As noted above, the coating apparatus 18, may an extruder 18a as discussed above, or a fluized bed 18b coating or fluidized bed with a spraying apparatus 18c. Such techniques are also discussed at www.vixtrex.com. As with the steps noted above, a feed coil of an insulation component such as wire is fed, for example over an entry winch under tension with an exit winch into the process. In all processes, it is preferred that the coil be textured and cleaned prior to processing to improve contact and adhesion of a coating onto the coiled substrate. The coil is also preferably pre-heated to remove moisture and prepare the coil for coating, e.g., in a fluidzed bed 18b of a powdered crosslinked polyether ether ketone composition. The powder melts and deposits on the coil. As with the extruder-coating noted above, the pre-heating for the other methods herein may also be carried out using radiant heat or infrared heating, induction heating coils or hot air convection.

When the coating apparatus 18 is a spray coating apparatus 18c, which may be used in conjunction with and fed by a fluidized bed of powder crosslinkable aromatic polymer composition, the coil enters over an entry winch 12 as noted above, and pre-treated by cleaning and/or texturing, and further may be primed such as with an adhesive or a primer to enable the powder to adhere to the coil during coating. The coil may be coated in a suitable spray coating booth or other similar apparatus in which the powder crosslinkable aromatic polymer composition may be fed to the spraying device for spray coating the wire. An electrostatic charge may be imparted in certain applications for better coating coverage.

Thermal spray coating may also be used by melting a powder or solid form crosslinkable aromatic polymer composition in a thermal sprayer, wherein the polymer may be melted during the spraying step. The metling energy can be provided by electrical plasma, arc or by gas combustion.

After leaving the coating apparatus 18, such as fluidized bed 18b or after use of a thermal or electrostatic sprayer in a spray booth 18c or an extruder and die 18a, 20 as noted above, the coated substrate is then partially or fully cured using a suitable oven which may be, for example, in-line or tunnel oven 30. In the case of these process coating steps, a secondary process step may be used to remove porosity and/or increase density of the coated substrate prior to final curing.

Further after leaving the coating apparatus 18, instead of curing while coating, and depending on the intended cure profile and end properties, the crosslinkable aromatic polymer(s) may optionally be cured or fully cured in-line in an in-line curing step 22 which may include an infrared or convection tunnel oven 30. The length of the oven used will depend on the cure parameters of the crosslinkable aromatic polymer(s) and the desired residence time and process speed. It is also acceptable to use a radiant or infrared heat tunnel for this purpose to avoid heat loss associated with convection.

The post-cure profile can be determined and selected, in part, if desired, to balance product properties desired for an intended end product use application, including adjusting the mechanical properties, adhesion and ductility of the coatings applied. For example, a material may be prepared to exhibit higher tensile strength and a lower impact strength at a shorter cure time than may be produced at a longer cure time, and vice versa. The desired failure mode may also be taken into account in determining and selecting a cure profile, and the failure modes for a slower cure rate (speed) and a faster cure rate in material tests may differ depending on the cure profile in terms of the cure rate. For example, in a drop weight impact test, a brittle failure may be observed at a faster cure rate (speed), whereas in a tensile test, a ductile filaure may be observed at a lower cure rate.

For each of the above-noted coating apparatuses, after the coating step and optional curing of the crosslinkable aromatic polymer(s) in the oven, post-coating process steps may be employed if desired. Any such process steps as are known int the art or to be developed may be used to further process the coated material. In a preferred embodiment herein use of air and/or water to complete or adjust the curing reaction can be employed in a cooling step 24. This would apply, for example, in an embodiment when the product is cured in situ, and the material is molded or post-cured to yield a partially cured product, which is then sent into use in an elevated temperature end application, such as a downhole environment, and curing can be completed through exposure to the use temperatures in the actual application.

Optional release agents may be also applied to the extruded coating after the die to assist in preventing the crosslinkable (or at least partially crosslinked) aromatic polymer or blend thereof from sticking to itself when processed onto a take-up reel or similar device. Such release agents may be applied by sprays, dipping or brushing.

After a coated wire is wound on a reel or similar device using, e.g., a winder 32, it may be placed in a heating chamber, such as an oven, and subjected to a final batch curing step 34, during which it is further cured and/or post-cured (or post-cured in line) to form a final coated wire or other insulation component 36. Suitable post-curing temperatures will range generally from about 450° F. to about 900° F. depending on the crosslinkable aromatic polymers or blends thereof, and the applicable crosslinking reaction, as well as the thickness of the coating and exposure time of the coating in the oven or other heating chamber.

In the exemplary process described above, the process components could be modified to adjust the process. For example, when the coating apparatus is an extruder with a die 18a, 20, more than one extruder may be used to provide multi-layer extrusion. Components may also be provided to allow multiple wire coils to be extruded and then later combined with other cable and the like to form multi-conductor cable. Post-processing components, such as printers or striping apparatus may be provided as well.

Further, with respect to the use of cross-head dies in an extrusion coating employed herein, they are generally of two varied types, pressure dies (wherein the die pressurizes the polymer against the wire inside the die, and tube dies in which the polymer does not press against the wire until the wire and polymer exit the die. Either of these dies may be employed for coating substrates such as wire, as well as other types of wire coating dies known or to be developed in the art.

In both types of cross-head dies, the die design of the cross-head die will influence the dimensional consistency of the extrudate. For instance, a longer dies with smoother finishes improve dimensional consistency by forming the melt over a longer time as the melt is cooled from the melt phase. Ideally, low coefficient of friction coatings, such as nickel-boron coatings (NiB), commercially available, e.g., as Nibore® and others, and electroless nickel PTFE coatings, commercially available, e.g., as Niflor® and others, may be applied to the inside surfaces of the die to further help dimensional consistency by reducing the coefficient of friction between the polymer melt and the die, reducing dead zones (i.e., regions with no flow) and lowering pressure required to extrude the melt, enabling the use of longer dies.

The final curing step in the preferred embodiment of FIG. 1 shows a batch final cure. The final curing (or post-curing) may be carried out in a number of ways, including in an oven on a reel, in a heat tunnel oven or in an end application in which a partly cured coated wire is employed in an end application in which it will experience heat that post-cures the wire in use (e.g., in a heated downhole environment). After any applicable inspection steps, such as those described below, the coil passes over the exit winch 14, which controls tension in conjunction with the entry winch 12, and is preferably wound on a suitable winder 32.

Other post-coating processing options for the coating process herein may include inspection and defect detection, such as through measurement and evaluation of coated wire, for example, using a diameter gauge 38 and an eccentricity gauge 40. A thickness gauge, arc detector/shock detector 28 and voltage control 26, thickness detector and/or eddy diffusion detector may be used as well as other coating inspection and defect detection tools as are known in the art or to be developed.

Other optional components include in-line compounding components, pellet driers to remove moisture, cable pretreating baths used before heating or pre-heating the wire or cable components. Pre-cleaning equipment for removing any coating or treatment on the insulation component to be coated, or splicer and/or patching equipment, for reworking or fixing voids or areas without full coverage or conecting strands together, may also be employed. Such equipment is known in the art, and one skilled in the art, based on this disclosure, would understand that such options may be employed within the spirit and scope of this disclosure.

In embodiments herein using a crosslinking compound and/or crosslinking reaction additive(s), such as reaction control additives, the use of such optional crosslinking compounds and/or reaction additives, such as an inhibitor, can be varied and such materials may be introduced at varying times and locations during the extrusion and melt blending of the composition to give varying degrees of crosslinking as the composition enters into a forming die, such as a cross-head die for coating on the wire or other long component. Similarly, for embodiments using blends of two or more crosslinkable aromatic polymers of different reaction kinetics, the amount of each such polymer, e.g., two such polymers with different crosslinking rates, may also be adjusted to provide varying degrees of crosslinking at that same stage.

The crosslinkable aromatic polymers selected contribute to a crosslinked coating that is abrasion- and wear-resistant, but retains its ductility and can be pliable and demonstrate good bending ability at room temperature. The pliability can be enhanced by adjustment of the amount of crosslinking compound, by modification of crosslinking additives and/or by modification of the content of a particular crosslinkable polymer in a blend of two or more such polymers of different crosslinking kinetics, and/or by modification of the curing and post-curing temperatures and times.

The adhesion of the coatings herein whether a directly applied layer or an encapsulation or outer layer on a coated wire, is enhanced using various optional method steps. In one embodiment, the use of a functional reactive crosslinking compound in the composition may facilitate adhesion by the crosslinking compound acting as a coupling agent between the coating and substrate. In one embodiment herein, adhesion can be further enhanced to prevent delamination by preparing the exterior surface of the component to be coated through various preparation steps. One method is a thorough cleaning of the surface to reduce the presence of residual oils or dirt left from processing of the component (such as from drawing or cutting of wire). Glass or ceramic fillers employed can also be cleaned to remove oxide, pendant hydroxyl groups, sizing or coupling agents, or process oils for handling the fibers prior to applying the coatings.

In another embodiment, the surface may be roughened to allow polymer to flow into crevices and pits in the exterior surface to be coated. When the polymer cools, physical interlocking can occur. If the surface is not cleaned, however, the oils can be driven deeper into the surface of the wire or cable and result in issues from the physical interlock, so it is preferred that cleaning be employed prior to surface roughing and possibly after as well.

Chemical attraction or affinity can be provided through van der Waals forces or chemical bonds induced though chemical modification of the exterior surface of the component to be coated. One method step of doing so can include use of a primer on, e.g., a metal surface to prepare it for enhanced bonding with a coating as is known in the art. Further primers that are multi-functional molecules can provide a reactive moiety for boning or adhesion to the surface to be coated. Such moieties can react with a chemically similar moiety or reactive moiety on in the coating. For glass and ceramic surfaces, silane-based coupling agents may be employed that can enhance affinity of the coating to the surface. For example, phenyl silanes are now to be useful as coupling agents for ceramic oxides or silica to promote van der Waals attraction of the polymer to a more chemically treated substrate surface.

As mentioned above, additives may be included also to adjust the CTE of the crosslinkable aromatic polymer(s) so that they more closely approach that of the exterior surface of the component to be coated. However, in some cases, too low a CTE for the crosslinkable aromatic polymer(s) in the composition may impact its ductility or strength so that such fillers must be optimized if CTE adjustment is desired.

In a further embodiment, a base or intermediate layer may first be provided to the component that is preferably somewhat more compatible with the surface of the component to be coated than the selected crosslinkable aromatic polymer or blend thereof. Such a coating may be applied in advance or applied through co-extrusion in the cross-head die. An example may be use of a base or intermediate layer of an uncrosslinkable aromatic polymer which may or may not be filled. That layer is then coated and/or encapsulated by the crosslinkable aromatic polymer or blend thereof to form a coating of crosslinked aromatic polymer or a coating of a blend thereof, or an encapsulation thereof on the intermediate or base layer on the component to be coated. In a preferred embodiment, e.g., a commercial PEEK can be filled with glass beads which can be extruded as an intermediate layer on a wire, while the composition including the crosslinkable aromatic polymer(s) is co-extruded over the intermediate layer such that the crosslinked coating provides its enhanced properties to protect the inner layer of uncrosslinked filled PEEK which may provide greater adhesion, but have less superior coating properties in terms of its wear factor and wear-resistance as well as its chemical resistance, strength and abrasion resistance.

Such crosslinked aromatic polymer coatings formed by the methods herein may be used in a variety of possible end uses and environments, including where there are any of the following conditions alone or in combination: high temperatures, chemically corrosive or harsh chemical environments, and applications where toughness, abrasion-resistance and/or chemical resistance are important and/or where electrical insulation is key. For example, such materials can be used in electrical, aerospace, medical, automotive, and chemical fluid handling end applications. The crosslinked aromatic polymer coatings formed from the method herein may be employed to various insulation components in these fields. As used in this instance, high temperatures generally include those that are at or exceed the glass transition of the particular polymer in use, for example, in PEEK, such temperatures are usually from 300° F. to 500° F.

With respect to chemically corrosive or harsh chemical environments, such materials and coatings are suitable for use in end applications in compliance with ISO and NORSOK Certifications. ISO (the International Organization for Standardization) is a worldwide federation of national standards bodies. ISO 23936-1 specifically addresses the resistance of thermoplastics to the deterioration in properties that can be caused by physical or chemical contact with media related to production in the petroleum, petrochemical and natural gas industries. NORSOK is an internationally recognized standard developed by the Norwegian petroleum industry. The NORSOK M-710, Rev.3 specification standard went into effect in 2014, providing requirements to be met for non-metallic seals, seat and backup materials for use in applications such as subsea, control systems and valves. The standard in Revision 3 subjects tested materials to significantly harsher conditions than in the prior standard.

Extruded filaments formed of crosslinked aromatic polymers herein may be formed so as to have a bend radius/diameter of 1.7 mm in the extruded filament that, when cured under typical conditions exhibits sufficient toughness so that it can be tied into a knot.

Examples of more particular end applications for the insulation component coatings herein include, but are not limited to: wirelines for telemetry transition during oil and gas drilling operations, logging while drilling, wires used in motor windings, motor components such as stators and rotors, for use in electrical motors in transportation applications (electric vehicles, heavy equipment motors), chemical pumps, electronic actuators for control of aircraft flaps, ailerons, and landing gear, telemetry cables of engine sensors in aircraft or in turbine power plants, cables for 5G (and 6G) transmission equipment, and encapsulation of various sensors or RFID chips which require leak free encapsulation with a higher temperature chemically resistant polymeric coating. The method is also useful for providing coating of fiber optic cables, piezoelectric sensors, and to protect the encapsulated components from attack by outside chemicals (acids, bases) or moisture.

The invention will now be described with respect to the following non-limiting examples.

### Example 1

In the Examples herein, the examples support the ability to tailor or adjust the desired product properties for an insulation in an end product use in which it is to be employed by modifying the degree of curing and crosslinking by, e.g., using a crosslinking compound and adjusting the amount of crosslinking compound incorporated in the crosslinkable organic polymer composition. In addition to this or alternatively, the cure conditions (rate, time and/or temperature) applied in curing the crosslinkable organic polymer composition may be adjusted to modify the degree of curing and crosslinking. Adjustments made to the crosslinking compound, conditions or other ways to control the degree of crosslinking allow for modifications in key material properties desired in a given end product for intended use. Further, such properties can be particularly improved and enhanced to achieve performance that is better than the same organic polymer when it is not crosslinked.

For example, in one instance, if ductility and impact resistance are important in a thin coating application, a crosslinking profile and system may be determined and selected to maintain the ductility and impact resistance while improving the thermal mechanical and thermal insulation properties as well as improved environmental aging resistance. In another instance, coating applications may focus more in improving thermal mechanical and thermal insulation properties as well as environmental aging resistance while allowing some decrease in ductility. In this case, a different crosslinking system or approach may be used to increase the crosslinking, such as by using a crosslinking compound in a higher amount, to enhance desired mechanical properties. This ability to tailor the end properties is now demonstrated further below.

In this example, material compositions used included a diol crosslinking compound mixed with a commercial PEEK (Vestakeep® 5000P, from Evonik). The crosslinking compound was added in a mixture with an optional crosslinking reaction control additive. Specifically, varying amounts of a crosslinking compound, (9,9′-(bisphenyl-4,4′-diyl)bis(9H-fluoren-9-ol) with 0.75% lithium acetate were combined with the PEEK. The blended powder mixture was compounded in a twin screw extruder with the PEEK to form pellets. The pellets were injection molded into ASTM Type V and ASTM Type I tensile bars and discs (3″) for impact testing. Two important coating properties, ductility and impact resistance for a thin coating were evaluated. The ductility was evaluated based on the room temperature elongation at break using the ASTM Type V tensile bar. The impact resistance was demonstrated by the Gardner impact test. The Gardner Impact test according to ASTM D5420 was carried out using 3″ discs. A falling weight was released from various heights and impacted a strike which impacted the loaded specimen. The energy required to break the surface in pounds-force (lb_{f}) was calculated from the experimental data. Thermal mechanical properties were evaluated by tensile modulus at 260° C. using the ASTM Type I bar tensile testing at 260° C. The glass transition temperature and rubbery plateau modulus were measured by ARES-G2 using torsional geometry.

The test results are summarized in Table 1 below. The control used was a non-crosslinked PEEK of the same type used to prepare the crosslinked material. The crosslinked PEEK materials prepared were made at four different levels of crosslinking compound from lowest (A) to highest (D). Each of the crosslinked samples included the same cure profile to complete the cure. The modification of the properties as noted above is shown by the change in the amount of crosslinking compound used to increase or decrease the amount of crosslinking in the cured material.

TABLE 1

| Sample | Control | Sample A | Sample B | Sample C | Sample D |
|---|---|---|---|---|---|
| Crosslinking | 0 | 4 | 8 | 12 | 17 |
| Compound (%) | | | | | |

Material Properties

| | | | | | | | | | |
|---|---|---|---|---|---|---|---|---|---|
| Degree of Cure | — | partial | full | partial | full | partial | full | partial | full |
| RT Elongation | 66 | 78 | 47 | 75 | 48 | 84 | 38 | 107 | 15 |
| (%) | | | | | | | | | |
| Impact Mean | >160 | >160 | 106 | 144 | 43 | 58 | 28 | 29 | 61 |
| Failure Energy | | | | | | | | | |
| (lb_{f}) | | | | | | | | | |
| HT Modulus at | 0.27 | — | 0.32 | — | 0.51 | — | 0.56 | — | 0.8 |
| 260° C. (GPa) | | | | | | | | | |
| Tg by DMA | 150 | — | 156 | — | 160 | — | 162 | — | 170 |
| onset (° C.) | | | | | | | | | |
| Rubbery Plateau | Melt | — | 1.2 | — | 2.3 | — | 3.7 | — | 10.8 |
| Modulus (MPa)_{—} | | | | | | | | | |

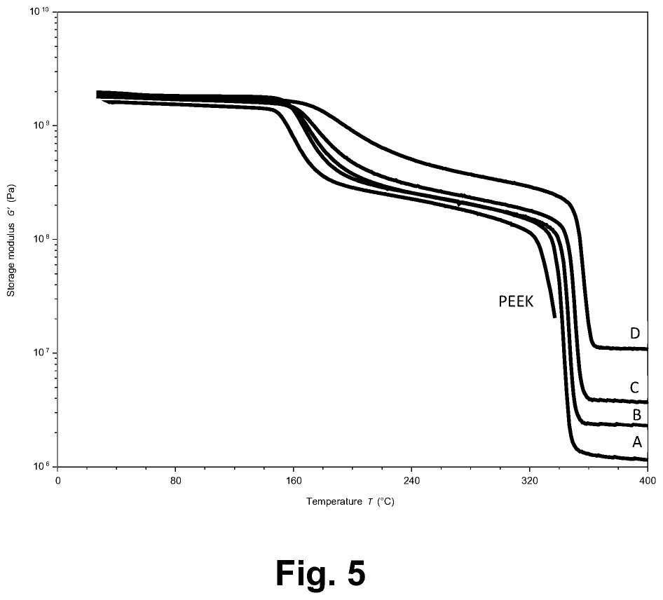

FIG. 5 includes a dynamic mechanical analysis (DMA) curve of the PEEK Control material versus the crosslinked PEEK Samples A through D. With respect to the crosslink density, ν, it is proportional to the reciprocal of the mass between crosslinks, expressed as the molecular weight between crosslinks, M_{c}. Less mass between crosslinks indicates a higher the crosslink density. M_{c} may be calculated from the shear storage modulus, G′, measured by DMA using the relationship:

$$Mc = \frac{RTd}{G {′}_{rubbery}}$$

wherein, M_{c} is the molecular weight between crosslinks, R is the universal gas constant, Tis the absolute temperature and d is the density of the polymer.

From this relationship, it is found that Shear modulus, G′, is inversely proportional to Mc, which means it is directly proportional to ν.

From the figures we can see that G′ increases with increase in % crosslinking additive as we mover from 4% to 17% additive, and it also changes with cure state. This means that the crosslink density increased, and the Mc decreased.

As indicated in FIG. 5, the morphology and material characteristics of the crosslinked PEEK Samples were dependent upon the level of the crosslinking compound after cure. The material characteristics such as chain mobility (as evidenced by the slope in T_{g} transition, wherein the lower the slope, the lower the mobility), the crosslink density (as evaluated by the rubbery plateau modulus, wherein the higher the rubbery plateau modulus, the higher the crosslink density), the glass transition temperature (T_{g}), crystalline morphology (i.e., the level of crystallinity and melting point) were all increased with the increase in crosslinking compound from Sample A to D.

Thermal mechanical properties, such as strength and stiffness, and the thermal insulation properties, such as resistivity and dielectric strength at elevated temperature, and the chemical resistance also will experience enhancement in crosslinked PEEK materials as the level of crosslinking increases. Ductility, though, is expected to decrease as the level of crosslinking increases after cure. The impact resistance is dependent upon how the stress is transferred, which is related to the polymer network. The crosslinking level effects on some material properties are summarized in Table 1 above. In a wire coating end use, by carefully selecting the material composition, a composition can be prepared according to the invention herein that has comparable ductility and impact resistance to non-crosslinked PEEK, but with the added advantages of the crosslinked material such as better thermal mechanical properties, thermal insulation and chemical resistance. Furthermore, the crosslinking compound, which itself in some quantities acts as a plasticizer, and can also act as a curative depending on the level provided and the cure conditions, enables the compositions herein to provide coatings, such as wire coatings, with properties adjusted for desired product uses in intended end applications.

A higher degree of crosslinking (and a greater amount of crosslinking compound) is generally favorable for insulation applications requiring enhanced properties such as thermal mechanical, thermal insulation and chemical resistance properties, although ductility may be decreased to some extent. The greater enhancement in thermal mechanical properties, T_{g} and crosslink density of a composition having a higher degree of crosslinker (Sample D), was discussed above with respect to FIG. 5 and Table 1. With respect to that composition, wear resistance and thermal insulations properties are further demonstrated herein.

For Sample D, thrust washer samples were formed and selected for a nonabrasive wear test according to ASTM D 3702, and 1″ OD/0.188″ thickness button samples were also injection molded for a silica slurry abrasive test in a chemical mechanical planarization (CMP) process. The insulation properties of Sample D were studied using an RSA-G2 Solids Analyzer (TA Instruments) having a dielectric thermal analyzer (DETA) accessory (TA Instruments) using a button (having dimensions of 0.12 in. thickness and 0.5 in. diameter).

A nonabrasive wear test was performed according to ASTM D3702 under a PV of 5,000 psi-ft./min. The resulting wear factor (K) for a commercial PEEK (Victrix™ 450G) in an insulation coating was 451.4×10⁻¹⁰ in³ min/ft-lb-hr. The resulting wear factor (K) for the crosslinked PEEK Sample D was only 110.6×10⁻¹⁰ in³ min/ft-lb-hr. At this PV condition, K is about three times higher for the commercial PEEK than it is for the crosslinked PEEK, indicating superior wear resistance for the crosslinked PEEK.

An abrasive resistance of the material was evaluated in an abrasive silica slurry commonly tested in the chemical mechanical planarization (CMP) process and total weight loss during the 1 hour test was recorded. The crosslinked PEEK showed a weight loss of 0.0057 g, which was about two times less weight loss than the weight loss of the commercial non-crosslinked PEEK (0.0173 g).

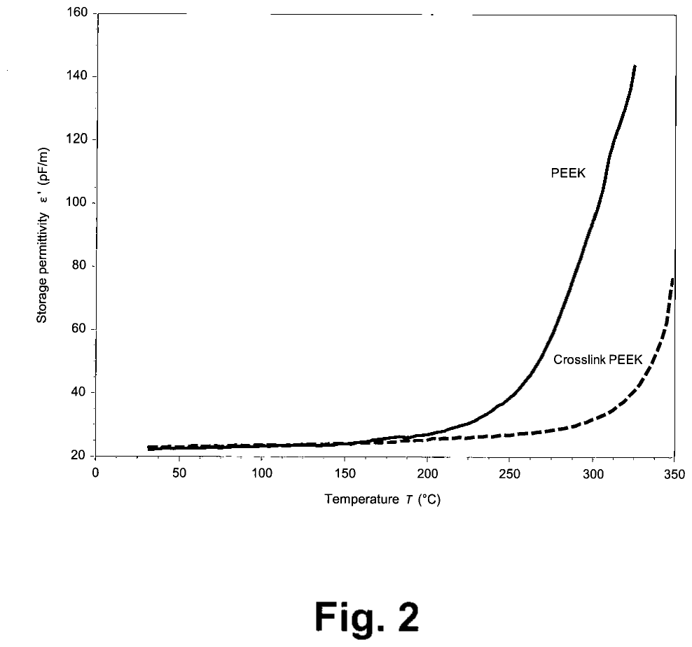

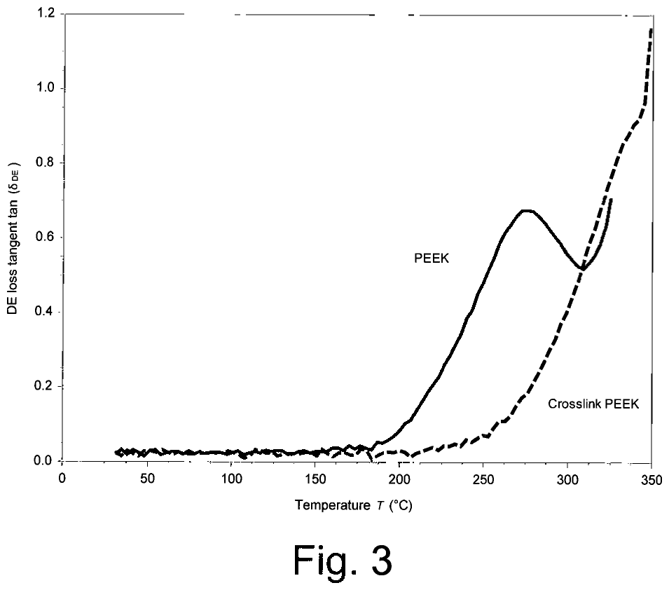

The insulation properties were demonstrated in FIG. 2 showing a plot of storage permittivity (ε′) measured in pF/m against temperature T (° C.) for each of the commercial PEEK and the crosslinked PEEK. FIG. 3 shows a plot of the dielectric loss tangent measured as tan (δ_{DE}) against T (° C.) for the same two materials. These above results demonstrated that the crosslinked PEEK provides significantly better insulation properties at elevated temperature as indicated by the lower storage permittivity and loss factor.

In further assessing a composition such as Sample D, it can be seen that ductility may be adjusted by cure conditions such as, for example, by variation in temperature and time. This is illustrated in Table 2 below, wherein a composition as in Sample D was cured at five different temperatures for the same amount of time, and at the same temperature for five different periods of time.

TABLE 2

| Material | Cure Conditions | RT Elongation (%) |
|---|---|---|
| Commercial PEEK | molded (not cured) | 66 |
| Sample D | partial cure (molded) | 107 |
| | 320° C./10 hr | 40 |
| | 320° C./18 hr | 31 |
| | 320° C./38 hr | 25 |
| | 320° C./47 hr | 25 |
| | 320° C./72 hr | 15 |
| | 290° C./72 hr | 50 |
| | 305° C./72 hr | 14 |
| | 310° C./72 hr | 15 |
| | 315° C./72 hr | 28 |

The above approaches and Example demonstrate that the material properties of crosslinked organic polymers such as the subject cross-linked PEEK samples herein may be adjusted to tailor them to desired property needs in an end product indicated for a particular application in use, by varying the level of crosslinking and the cure conditions. The crosslinked organic polymer compositions, such as the exemplified results for the cross-linked PEEK compositions and samples demonstrate comparable ductility and impact resistance to the commercial, uncrosslinked equivalent organic polymer, in this case an uncrosslinked commercial PEEK, but are able also to provide superior wear and abrasion resistance, and insulation properties at elevated temperatures, each of which provides beneficial properties for use in coatings applications, particularly for insulation component coatings such as wire coatings.

It would be understood by one skilled in the art, based on this disclosure, that similar enhanced properties would be expected in coatings formed from compositions using the various crosslinkable aromatic polymers herein (alone or in blended form) when used in the methods herein. Further, it would be understood that if no crosslinking compound(s) is/are used in crosslinking an organic polymer, that other methods to adjust the crosslinking level (use of blended polymers having different curing kinetics, different degrees of thermal or grafted crosslinking, use of reaction rate additives and the like) as described above can also be used to vary the degree of crosslinking and provide varying end properties as described herein.

### Example 2

The composition of Example 1, incorporating 17% of the crosslinking compound and the crosslinking reaction additive as noted was used to coat a 10-guage copper wire with a wire outer diameter of 0.102 in. and a desired outer diameter of the extruded crosslinked PEEK of 0.149 in. The cure profile for the polymer had a crossover time at 680° F. of 27.6 min., and at 788° F. of 4 minutes. As used herein, the crossover time is as it is commonly known in the art, the point at which the storage modulus and the loss modulus cross in a rheology experiment. It is a measurable point where the network structure is established, and the polymer no longer flows. It is also known as the gel point.

The crosslinked PEEK was extruded using a 30 mm single screw extruder with an L/D of 20:1 and using a screw with a compression ratio as low as 1:1. The residence time was calculated at 4 minutes with a throughput of 2.14 lbs/hr, given a screw volume of 3.6 in³. The wire was pulled through the cross-head die with a line speed of 6.9 ft./min.

### Example 3

The coated wire of Example 3 is preheated as an optional step to promote adhesion between the wire and the polymer. Wire is fed by a reel feed through a cross-head die while crosslinked PEEK is fed into the die to apply a coating to the exterior surface of the wire.

One minute at 420° C. can accomplish a partial cure (G′ modulus and G″ modulus converge) for the crosslinked PEEK such that an oven is used that is 6.9 feet (or longer).

After the oven, the crosslinked PEEK is further cured in air and is then cooled in water. A release agent is applied to the coating by spraying. The coated wire is rolled onto a reel. The reel is post-cured in an inert gas oven at temperatures of 450° F. to 900° F. depending on desired coating thickness.

### Example 4

A wire is coated in the same manner as Example 2, however, the degree of crosslinking (cure level) on the wire is increased with a reduced amount of crosslinking reaction control additive in comparison to that of Example 2. A crosslinking compound is combined in the composition along with a crosslinking reaction control additive that is a cure inhibitor, lithium acetate. The amount of the cure inhibitor is reduced to 0.1% to accelerate the crosslinking while monitoring the properties of the material within the extruder and as it enters the cross-head die.

### Example 5

A wire is coated in the same manner as Example 2, and the degree if crosslinking on the wire is increased by using little or no crosslinking reaction additive with respect to the inhibitor of Examples 2-4. The composition initially includes only the crosslinkable PEEK, and the crosslinking compound, and little or no cure inhibitor, are introduced to the PEEK melt until a position that is downstream of the melt. Thus, the composition is mixed through in-line compounding at the extruder. A twin-screw extruder is used for this purpose, with the wire passing through a main orifice of the twin-screw extruder. The crosslinking occurs in the melt state and the coating leaving the cross-head die is applied in a more highly cured state. A single screw extruder is also used with the same composition, and a feeder mechanism is chosen, and the input orifice positioned to introduce the materials with sufficient time for blending.

### Example 6

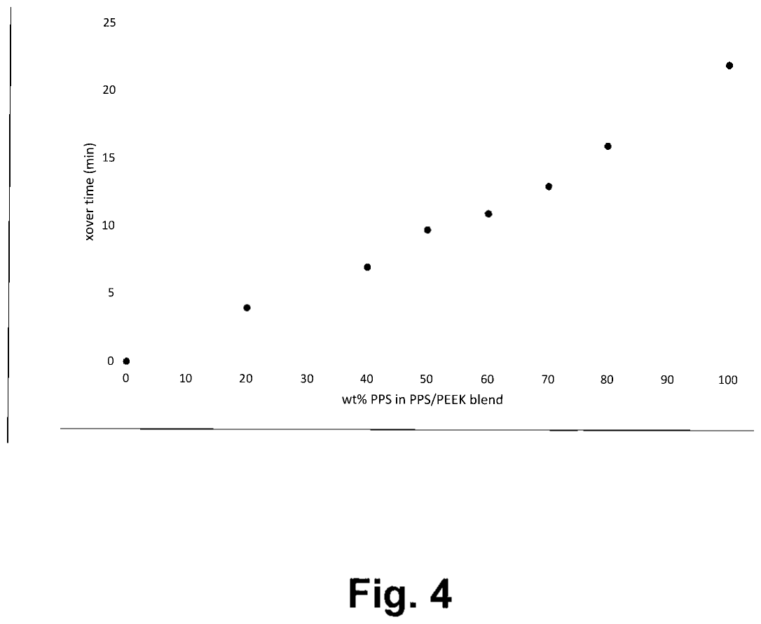

A wire is coated in the same manner as Example 3-4, the cure level of the wire is controlled in this Example by use of a two polymer blend using PPS and PEEK in amounts of 20% by weight of commercial PPS and 80% by weight of commercial PEEK based on a total weight of the polymers in the blend. The composition initially includes only PPS/PEEK blend, without a crosslinking compound or a crosslinking control additive. At a point downstream, a crosslinking compound is added to the melt of the blend of PPS/PEEK. The cure reaction kinetic of a blended composition of PPS (Ryton® 160QN from Solvay) and PEEK (Vestakeep™ 5000) was studied by crossover time which was measured at 360° C. in N₂ at 0.1% strain and 1 Hz oscillation by a rheometer (ARES-G2 from Tain Instruments) and the representation is shown in FIG. 4. A twin-screw extruder is used for this purpose, with the wire passing through a main orifice of the twin-screw extruder. The crosslinking occurs in the melt state and the coating leaving the cross-head die is applied in a more highly cured state. A single screw extruder is also used with the same composition, and a feeder mechanism is chosen. The input orifice is positioned to introduce the materials with sufficient time for blending.

### Example 7

Coatings are applied using crosslinkable aromatic polymers compositions according to Example 1 through Example 6, with reference to FIG. 1 by feeding a coil of copper wire 10 over an entry winch 12. The winch 12 is configured to work with an exit winch 14 to ensure adequate coil tension for coating between the entry and exit winches 12, 14. The coil is pre-heated in a pre-heating step 16 using an oven to enhance adhesion between the wire and the crosslinkable polymer(s) in the Example and to remove moisture. An extruder 18 is arranged perpendicularly to a cross-head die 20. The crosslinkable polymer is fed into the extruder where it is melted. The extruder barrel temperatures are 660° F. The cross-head die 20 is positioned at the end of the extruder and parallel to the processing directly 42. The wire is run through the cross-head die 20 at 680° F. at a coil speed of 69 ft./min. The cross-head die 20 turns the 90°, parallel to the line of the process and forms the melt over the wire. At various points in the process as noted in Examples 2-6, crosslinking compound and/or optional crosslinking additive such as an inhibitor are added depending on desired properties and crosslinking reaction kinetics. During this process, an in-line curing step 22 occurs. Further, a tunnel oven 30 is alternatively used for the in-line curing in one example herein. After exiting the cross-head die in an example herein, the coated wire is passed through a water cooling bath 24.

The wire passes over an exit winch 14 and a voltage control 26, and a spark detector 28. The wire is then wound on a winder 32 and subjected to final batch curing in a final batch curing step 34 to form a coated wire 36. The final batch curing step (post-curing) is conducted with elevated temperature heating in an oven to ensure full curing of the crosslinkable polymers in the composition.

In a further example of this process, after exiting the cross-head die, the wire enters a tunnel oven 30 for partial or full curing. Time and temperature and length of the oven are selected based on the level of curing desired and line speed as discussed above in this disclosure. Radiant/infrared heat tunnels are used in a further example of this process herein as a more efficient in-line curing component due to lack of heat loss to the environment associated with convection of an in-line tunnel oven.

In another example of the process herein, after the tunnel oven 30, the wire passes through a cooling station 24, which involves passing the wire through a water bath. A spark detector 28 is used to detect defects in insulation properties of the coating by using high voltage. A diameter gauge 38 and an eccentricity gauge 40 are employed in a further example herein as an example of one of several ways in which an in-line inspection of the coated wire may be carried out. In this example, the wire passes over the exit winch 14 and the voltage control 26 and then finishes on a winder 32. The reel is filled with coated wire coil and then is subjected to a final batch curing step 34 to form a coated wire 36.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of coating an insulation component with a crosslinked aromatic polymer for use in a high temperature, high voltage and/or corrosive environments, comprising:
providing a composition comprising at least one crosslinkable aromatic polymer;
heat processing the composition;
applying a coating of the composition to an exterior surface of an insulation component; and
crosslinking the aromatic polymer in the composition to provide a coated insulation component.

2. The method according to claim 1, wherein crosslinking is initiated by application of heat.

3. The method according to claim 1, wherein the at least one crosslinkable aromatic polymer comprises a self-crosslinking aromatic polymer.

4. The method according to claim 1, wherein crosslinking is initiated after coating the insulation component.

5. The method according to claim 1, wherein the crosslinkable aromatic polymer is at least partially crosslinked during the coating of the insulation component.

6. The method according to claim 1, wherein the crosslinking occurs generally simultaneously with the coating of the insulation component.

7. The method according to claim 1, wherein the at least one crosslinkable aromatic polymer is selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof.

8. The method according to claim 7, wherein the aromatic polymer comprises one or more functionalized groups for crosslinking.

9. The method according to claim 7, wherein the aromatic polymer is a polyarylene selected from polyetherketone, polyetheretherketone, polyetherdiphenylether ketone, polyetherketone ketone, and blends, co-polymers and alloys thereof.

10. The method according to claim 7, wherein the at least one crosslinkable polymer is a polyarylene ether having repeating units along its backbone according to the structure of formula (I): 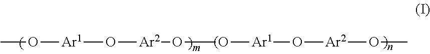
wherein Ar¹, Ar², Ar³ and Ar⁴ are identical or different aryl radicals, m=0 to 1, and n=1-m.

11. The method according to claim 12, wherein the at least one crosslinkable aromatic polymer has repeating units along its backbone having the structure of formula (II):

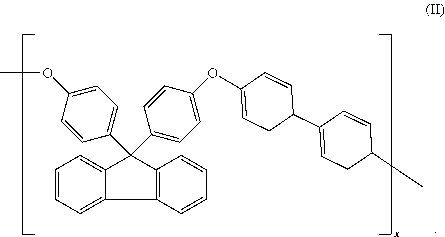

12. The method according to claim 7, wherein the at least one crosslinkable aromatic polymer comprises a blend of at least two different polymers, each having at least one reaction kinetics property that is different from the other, wherein the at least one reaction kinetics property comprises one or more selected from a crosslinking reaction, a crosslinking reaction rate, and a thermal property.

13. The method according to claim 12, wherein the at least one reaction kinetics property is the crosslinking reaction rate.

14. The method according to claim 12, wherein the blend is selected from the group of polyphenylene sulfide and polyetherether ketone; polyphenylene oxide and polyphenylene sulfide; and polyetherimide and polyphenylene sulfide.

15. The method according to claim 12, wherein the blend comprises at least one first crosslinkable aromatic polymer that has a crosslinking reaction rate that is slower than at least one second crosslinkable aromatic polymer.

16. The method according to claim 15, further comprising slowing the crosslinking reaction rate of the second crosslinkable aromatic polymer by incorporating the first crosslinkable aromatic polymer into the second crosslinkable aromatic polymer in an amount that is about 1 to about 50 percent by weight based on the total weight of the first and the second crosslinkable aromatic polymers to provide a degree of crosslinking for the blend that facilitates melt processing and post-curing of the blend.

17. The method according to claim 15, further comprising accelerating the crosslinking reaction rate of the first crosslinkable aromatic polymer by incorporating the second crosslinkable aromatic polymer into the first crosslinkable aromatic polymer in an amount that is about 1 to about 50 percent by weight based on the total weight of the first and the second crosslinkable aromatic polymers to provide a degree of crosslinking for the blend that facilitates melt processing and post-curing of the blend

18. The method according to claim 15, wherein the at least one first crosslinkable polymer is polyphenylene sulfide and wherein the at least one second crosslinkable polymer is selected from the group consisting of (i) one or more polyarylene selected from polyetherketone, polyetheretherketone, polyetherdiephenylether ketone, polyetherketone ketone, and blends, co-polymers and alloys thereof; (ii) one or more of polysulfone, polyphenylsulfone, polyethersulfone, co-polymers and allows thereof; and (iii) one or more of polyimide, thermoplastic polyimide, polyetherimide, and blends, co-polymers and allows thereof.

19. The method according to claim 1, wherein the composition further comprises at least one crosslinking compound that has a structure according to one of the following formulae: 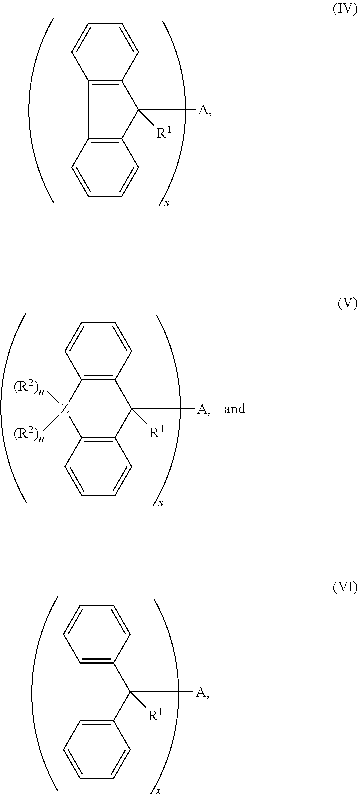
wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

20. The method according to claim 19, wherein the at least one crosslinking compound has a structure according to formula (IV) and is selected from the group consisting of

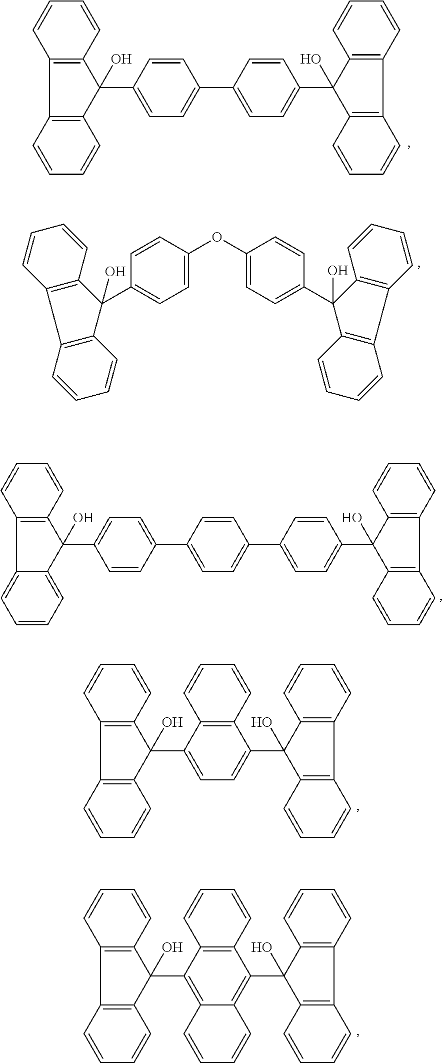 [SMILES: OC1(c2ccc(-c3ccc(C4(O)c5ccccc5-c5ccccc54)cc3)cc2)c2ccccc2-c2ccccc21 ; OC1(c2ccc(Oc3ccc(C4(O)c5ccccc5-c5ccccc54)cc3)cc2)c2ccccc2-c2ccccc21 ; OC1(c2ccc(-c3ccc(-c4ccc(C5(O)c6ccccc6-c6ccccc65)cc4)cc3)cc2)c2ccccc2-c2ccccc21 ; OC1(c2ccc(C3(O)c4ccccc4-c4ccccc43)c3ccccc23)c2ccccc2-c2ccccc21 ; OC1(c2c3ccccc3c(C3(O)c4ccccc4-c4ccccc43)c3ccccc23)c2ccccc2-c2ccccc21]

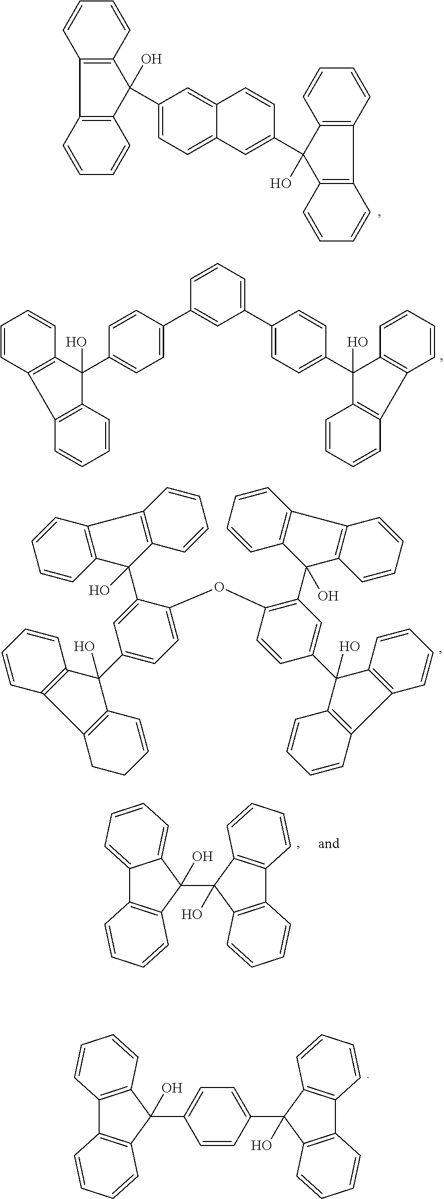

21. The method according to claim 19, wherein the at least one crosslinking compound has a structure according to formula (V) and is selected from a group consisting of:

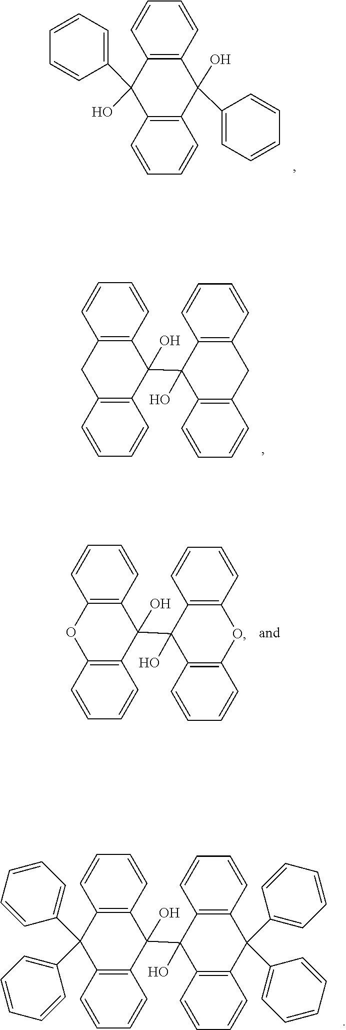 [SMILES: OC1(c2ccccc2)c2ccccc2C(O)(c2ccccc2)c2ccccc21 ; OC1(C2(O)c3ccccc3Cc3ccccc32)c2ccccc2Cc2ccccc21 ; OC1(C2(O)c3ccccc3Oc3ccccc32)c2ccccc2Oc2ccccc21 ; OC1(C2(O)c3ccccc3C(c3ccccc3)(c3ccccc3)c3ccccc32)c2ccccc2C(c2ccccc2)(c2ccccc2)c2ccccc21]

22. The method according to claim 19, wherein the at least one crosslinking compound has a structure according to formula (VI) and is selected from the group consisting of:

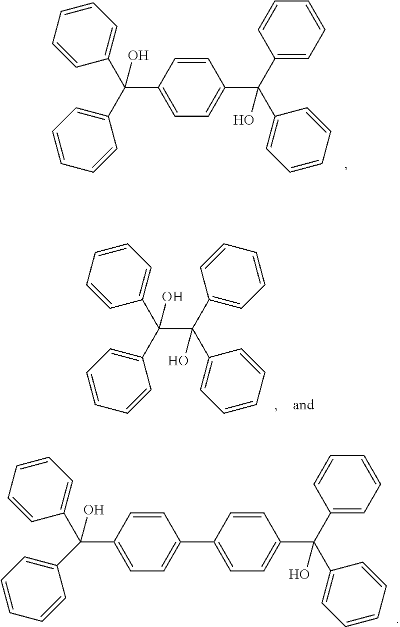 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

23. The method according to claim 19, wherein A has a molecular weight of about 1,000 g/mol to about 9,000 g/mol.

24. The method according to claim 23, wherein A has a molecular weight of about 2,000 g/mol to about 7,000 g/mol.

25. The method according to claim 19, wherein the at least one crosslinking compound is present in the composition in an amount of about 1% by weight to about 50% by weight of an unfilled weight of the composition.

26. The method according to claim 19, wherein a weight ratio of the aromatic polymer to the crosslinking compound in the composition is about 1:1 to about 100:1.

27. The method according to claim 19, wherein the composition further comprises a crosslinking reaction control additive selected from a cure inhibitor or a cure accelerator.

28. The method according to claim 27, wherein the crosslinking reaction control additive is present in the composition in an amount of about 0.01% to about 15% by weight of the crosslinking compound.

29. The method according to claim 27, wherein the crosslinking reaction control additive is a cure inhibitor comprising lithium acetate.

30. The method according to claim 27, wherein the crosslinking reaction control additive is a cure accelerator comprising magnesium chloride.

31. The method according to claim 1, wherein the composition comprises one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, carbon nanotubes and fullerene tubes.

32. The method according to claim 31, wherein the composition comprises about 0.5% by weight to about 65% by weight of the one or more additives and/or one or more fillers.

33. The method according to claim 1, wherein the composition further comprises a crosslinking compound.

34. The method according to claim 1, wherein the heat processing of the composition further comprises extruding the composition for coating the insulation component.

35. The method according to claim 34, wherein the composition is extruded through a cross-head die.

36. The method according to claim 34, wherein the extruder comprises is a twin-screw extruder.

37. The method according to claim 34, wherein curing occurs at least partially in an oven.

38. The method according to claim 37, wherein the oven is an infrared or convection oven.

39. The method according to claim 37, further comprising curing and/or post-curing the crosslinkable aromatic polymer after coating in the oven.

40. The method according to claim 37, wherein the residence time in the oven and/or the cross-linking rate are controlled.

41. The method according to claim 1, further comprising preparing the exterior surface of the insulation component to enhance bonding.

42. The method according to claim 41, wherein the exterior surface is prepared by at least one of cleaning, roughening and/or chemically modifying the surface.

43. The method according to claim 41, wherein the exterior surface is prepared by chemically modifying the exterior surface using a primer and/or a coupling agent.

44. The method according to claim 1, wherein applying a coating to the exterior surface of the insulation component comprises applying the composition directly to the exterior surface of the insulation component.

45. The method according to claim 44, wherein the exterior surface is prepared by at least one of cleaning the surface, roughening the surface and/or chemically modifying the surface.

46. The method according to claim 1, further comprising applying at least one intermediate layer to the exterior surface of the insulation product prior to applying the coating of the composition.

47. The method according to claim 46, wherein the at least one intermediate layer comprises the ability to enhance bonding with the exterior surface of the insulation component.

48. The method according to claim 46, wherein the coating of the composition encapsulates the insulation component.

49. The method according to claim 1, further comprising applying a release agent to the coating prior to the coating contacting another surface.

50. The method according to claim 1, wherein the insulation component is selected from wire, metallic and/or fiber optic cable, hybrid cables, telemetry cables, sensors, RFID chips, piezoelectric sensors, cables or wires for logging while drilling, motor windings, motor rotors, motor stators, chemical pumps, electronic actuators for aircraft, and 5G transmission cables.

51.-69. (canceled)
